(19) United States
(12) Patent Application Publication
(10) Pub. No.: US 2013/0207965 A1
(43) Pub. Date: Aug. 15, 2013

(54) IMAGE PROCESSING APPARATUS AND NON-TRANSITORY COMPUTER-READABLE RECORDING MEDIUM

(71) Applicant: Fumio HORI, Tokyo (JP)

(72) Inventor: Fumio HORI, Tokyo (JP)

(73) Assignee: OLYMPUS CORPORATION, Tokyo (JP)

(21) Appl. No.: 13/610,259

(22) Filed: Sep. 11, 2012

(30) Foreign Application Priority Data
Feb. 14, 2012 (JP) P2012-029666

(51) Int. Cl. G06T 15/00

(52) U.S. Cl. 345/419

(57) ABSTRACT

An image processing apparatus may include a display unit configured to display an image of an observation target and an image of an object having a pre-calculated three-dimensional shape corresponding to the observation target, an adjustment unit configured to adjust a pose of at least one of the image of the observation target and the image of the object so that the pose of the image of the observation target is close to the pose of the image of the object, a processing unit configured to perform a process of modifying the object for the image of the object based on standard points designated on the image of the object after the adjustment unit performs the adjustment, and a change unit configured to change the pose of the image of the object after the processing unit performs the process.

### BACKGROUND OF THE INVENTION

1. Field of the Invention

The present invention relates to an image processing apparatus and a non-transitory computer-readable recording medium storing program for processing an image of an observation target.

Priority is claimed on Japanese Patent Application No. 2012-029666, filed Feb. 14, 2012, the content of which is incorporated herein by reference.

2. Description of the Related Art

All patents, patent applications, patent publications, scientific articles, and the like, which will hereinafter be cited or identified in the present application, will hereby be incorporated by reference in their entirety in order to describe more fully the state of the art to which the present invention pertains.

In the related art, a blade within a jet engine is measured using an observation tool such as an endoscope or the like. Technologies suitable for measuring the blade and the like are disclosed in Japanese Examined Patent Applications, Second Publications Nos. H6-95009 and H8-12054. In the technology disclosed in Japanese Examined Patent Application, Second Publication No. H6-95009, a subject image captured by imaging a subject and a computer graphics (CG) image generated by CG are displayed on a monitor.

In the technology disclosed in Japanese Examined Patent Application, Second Publication No. H8-12054, an image captured by an inspection target and a simulation graphic generated from data defining the dimensions of the inspection target are displayed on a monitor.

In the technologies disclosed in Japanese Examined Patent Applications, Second Publications Nos. H6-95009 and H8-12054, an observer can visually recognize a defect as a difference between the image of the observation target and the CG image or the simulation graphic by comparing the image of the observation target having the defect to the CG image or the simulation graphic generated from data of a non-defective measurement target.

### SUMMARY

The present invention provides an image processing apparatus and a non-transitory computer-readable recording medium storing program capable of easily visually recognizing the state of a defect.

An image processing apparatus in accordance with the present invention may include a display unit configured to display an image of an observation target and an image of an object having a pre-calculated three-dimensional shape corresponding to the observation target, an adjustment unit configured to adjust a pose of at least one of the image of the observation target and the image of the object so that the pose of the image of the observation target is close to the pose of the image of the object, a processing unit configured to perform a process of modifying the object for the image of the object after the adjustment unit performs the adjustment, and a change unit configured to change the pose of the image of the object after the processing unit performs the process.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a block diagram illustrating a configuration of a blade inspection system in accordance with a first preferred embodiment of the present invention;

FIG. 2 is a block diagram illustrating a configuration of an endoscope apparatus having the blade inspection system in accordance with the first preferred embodiment of the present invention;

FIG. 3 is a block diagram illustrating a configuration of a blade inspection system (modified example) in accordance with the first preferred embodiment of the present invention;

FIG. 4 is a block diagram illustrating a configuration of a blade inspection system (modified example) in accordance with the first preferred embodiment of the present invention;

FIG. 5 is a block diagram illustrating a configuration of a personal computer (PC) provided in the blade inspection system (modified example) in accordance with the first preferred embodiment of the present invention;

FIG. 6 is a reference diagram illustrating a screen of three-dimensional (3D) measurement software in accordance with the first preferred embodiment of the present invention;

FIG. 7 is a reference diagram illustrating a relationship between a 3D object and a camera pose in accordance with the first preferred embodiment of the present invention;

FIGS. 8A and 8B are reference diagrams illustrating a relationship between a 3D object and a camera pose in accordance with the first preferred embodiment of the present invention;

FIGS. 9A and 9B are reference diagrams illustrating a relationship between a 3D object and a camera pose in accordance with the first preferred embodiment of the present invention;

FIGS. 10A and 10B are reference diagrams illustrating a relationship between a 3D object and a camera pose in accordance with the first preferred embodiment of the present invention;

FIG. 11 is a flowchart illustrating an operation procedure based on the 3D measurement software in accordance with the first preferred embodiment of the present invention;

FIG. 12 is a flowchart illustrating an operation procedure based on the 3D measurement software in accordance with the first preferred embodiment of the present invention;

FIG. 13 is a reference diagram illustrating an initial pose of the camera pose in accordance with the first preferred embodiment of the present invention;

FIG. 14 is a reference diagram illustrating an initial pose of the camera pose in accordance with the first preferred embodiment of the present invention;

FIG. 15 is a flowchart illustrating an operation procedure based on the 3D measurement software in accordance with the first preferred embodiment of the present invention;

FIGS. 16A, 16B, and 16C are reference diagrams illustrating content of a camera-pose setting process in accordance with the first preferred embodiment of the present invention;

FIG. 17 is a flowchart illustrating an operation procedure based on the 3D measurement software in accordance with the first preferred embodiment of the present invention;

FIGS. 18A, 18B, and 18C are reference diagrams illustrating content of a reference-point (measurement) designation process in accordance with the first preferred embodiment of the present invention;

FIG. 19 is a flowchart illustrating an operation procedure based on the 3D measurement software in accordance with the first preferred embodiment of the present invention;

FIGS. 20A, 20B, and 20C are reference diagrams illustrating content of a reference-point (3D) designation process in accordance with the first preferred embodiment of the present invention;

FIG. 21 is a reference diagram illustrating a method of calculating three-dimensional coordinates in accordance with the first preferred embodiment of the present invention;

FIG. 22 is a reference diagram illustrating a method of calculating three-dimensional coordinates in accordance with the first preferred embodiment of the present invention;

FIG. 23 is a reference diagram illustrating a method of calculating three-dimensional coordinates in accordance with the first preferred embodiment of the present invention;

FIG. 24 is a reference diagram illustrating a method of calculating three-dimensional coordinates in accordance with the first preferred embodiment of the present invention;

FIG. 25 is a flowchart illustrating an operation procedure based on the 3D measurement software in accordance with the first preferred embodiment of the present invention;

FIG. 26 is a reference diagram illustrating content of a matching process in accordance with the first preferred embodiment of the present invention;

FIG. 27 is a flowchart illustrating an operation procedure based on the 3D measurement software in accordance with the first preferred embodiment of the present invention;

FIGS. 28A and 28B are reference diagrams illustrating reference points and a reference graphic in accordance with the first preferred embodiment of the present invention;

FIGS. 29A, 29B, 29C, and 29D are reference diagrams illustrating content of a matching process of a pan/tilt direction in accordance with the first preferred embodiment of the present invention;

FIGS. 30A, 30B, and 30C are reference diagrams illustrating a data list in accordance with the first preferred embodiment of the present invention;

FIGS. 31A and 31B are reference diagrams illustrating a data list in accordance with the first preferred embodiment of the present invention;

FIG. 32 is a reference diagram illustrating a data list in accordance with the first preferred embodiment of the present invention;

FIG. 33 is a flowchart illustrating an operation procedure based on the 3D measurement software in accordance with the first preferred embodiment of the present invention;

FIGS. 34A, 34B, 34C, and 34D are reference diagrams illustrating content of a matching process of a roll direction in accordance with the first preferred embodiment of the present invention;

FIG. 35 is a flowchart illustrating an operation procedure based on the 3D measurement software in accordance with the first preferred embodiment of the present invention;

FIGS. 36A, 36B, 36C, and 36D are reference diagrams illustrating content of a matching process of a zoom direction in accordance with the first preferred embodiment of the present invention;

FIG. 37 is a graph illustrating a relationship between a side length (3D) and a zoom-direction position of the camera pose in accordance with the first preferred embodiment of the present invention;

FIG. 38 is a flowchart illustrating an operation procedure based on the 3D measurement software in accordance with the first preferred embodiment of the present invention;

FIGS. 39A and 39B are reference diagrams illustrating content of a matching process of a shift direction in accordance with the first preferred embodiment of the present invention;

FIG. 40 is a reference diagram illustrating a device under test (DUT) after a 3D matching process and a 3D object in accordance with the first preferred embodiment of the present invention;

FIG. 41 is a flowchart illustrating an operation procedure based on the 3D measurement software in accordance with the first preferred embodiment of the present invention;

FIG. 42 is a reference diagram illustrating a screen of the 3D measurement software in accordance with the first preferred embodiment of the present invention;

FIG. 43 is a flowchart illustrating an operation procedure based on the 3D measurement software in accordance with the first preferred embodiment of the present invention;

FIGS. 44A and 44B are reference diagrams illustrating content of a 3D object modification process in accordance with the first preferred embodiment of the present invention;

FIGS. 45A and 45B are reference diagrams illustrating content of a 3D object modification process in accordance with the first preferred embodiment of the present invention;

FIGS. 46A and 46B are reference diagrams illustrating content of a 3D object modification process in accordance with the first preferred embodiment of the present invention;

FIG. 47 is a reference diagram illustrating content of a 3D object modification process in accordance with the first preferred embodiment of the present invention;

FIG. 48 is a reference diagram illustrating content of a 3D object modification process in accordance with the first preferred embodiment of the present invention;

FIGS. 49A and 49B are reference diagrams illustrating content of a 3D object modification process in accordance with the first preferred embodiment of the present invention;

FIG. 50 is a reference diagram illustrating content of a 3D object modification process in accordance with the first preferred embodiment of the present invention;

FIGS. 51A and 51B are reference diagrams illustrating a DUT after a 3D object modification process and a 3D object in accordance with the first preferred embodiment of the present invention;

FIG. 52 is a reference diagram illustrating a DUT after a 3D object modification process and a 3D object in accordance with the first preferred embodiment of the present invention;

FIG. 53 is a flowchart illustrating an operation procedure based on the 3D measurement software in accordance with the first preferred embodiment of the present invention;

FIGS. 54A and 54B are reference diagrams illustrating content of a 3D object modification process in accordance with the first preferred embodiment of the present invention;

FIGS. 55A and 55B are reference diagrams illustrating content of a 3D object modification process in accordance with the first preferred embodiment of the present invention;

FIG. 56 is a reference diagram illustrating content of a 3D object modification process in accordance with the first preferred embodiment of the present invention;

FIGS. 57A and 57B are reference diagrams illustrating content of a 3D object modification process in accordance with the first preferred embodiment of the present invention;

FIG. 58 is a reference diagram illustrating content of a 3D object modification process in accordance with the first preferred embodiment of the present invention;

FIGS. 59A and 59B are reference diagrams illustrating a DUT after a 3D object modification process and a 3D object in accordance with the first preferred embodiment of the present invention;

FIG. 60 is a reference diagram illustrating a DUT after a 3D object modification process and a 3D object in accordance with the first preferred embodiment of the present invention;

FIGS. 61A and 61B are reference diagrams illustrating content of a 3D object modification process in accordance with the first preferred embodiment of the present invention;

FIGS. 62A and 62B are reference diagrams illustrating content of a 3D object modification process in accordance with the first preferred embodiment of the present invention;

FIGS. 63A and 63B are reference diagrams illustrating content of a 3D object modification process in accordance with the first preferred embodiment of the present invention;

FIG. 64 is a reference diagram illustrating content of a 3D object modification process in accordance with the first preferred embodiment of the present invention;

FIGS. 65A and 65B are reference diagrams illustrating a DUT after a 3D object modification process and a 3D object in accordance with the first preferred embodiment of the present invention; and

FIG. 66 is a block diagram illustrating a functional configuration of a central processing unit (CPU) of a control computer provided in the blade inspection system in accordance with the first preferred embodiment of the present invention.

### DETAILED DESCRIPTION OF THE PREFERRED EMBODIMENTS

The present invention will be now described herein with reference to illustrative preferred embodiments. Those skilled in the art will recognize that many alternative preferred embodiments can be accomplished using the teaching of the present invention and that the present invention is not limited to the preferred embodiments illustrated for explanatory purpose.

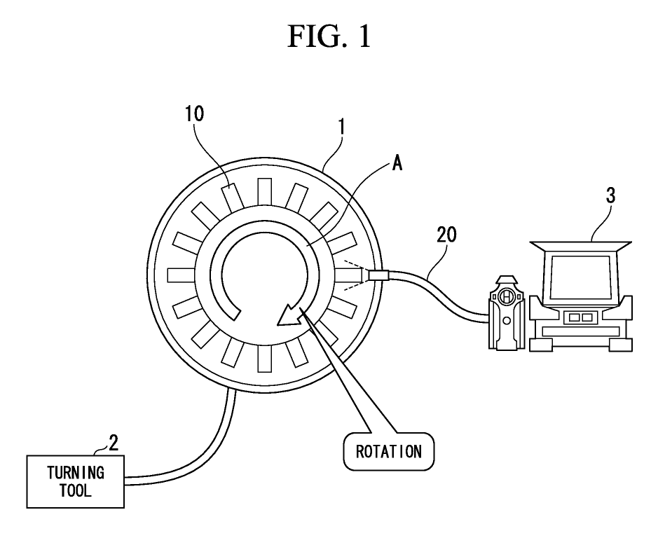

FIG. 1 illustrates a configuration of a blade inspection system in accordance with the first preferred embodiment of the present invention. In a jet engine 1, a plurality of turbine blades 10 (or compressor blades), which are inspection targets, are periodically arranged at predetermined intervals. In addition, a turning tool 2, which rotates the turbine blades 10 in a rotation direction A at a predetermined speed, is connected to the jet engine 1. In the first preferred embodiment, the turbine blades 10 are in a constantly rotated state while an image of the turbine blades 10 is captured.

In the first preferred embodiment, an endoscope apparatus 3 is used to acquire the image of the turbine blades 10. An insertion unit 20 of the endoscope apparatus 3 is inserted into the jet engine 1, and the image of the turbine blades 10 in rotation is captured by the insertion unit 20. In addition, 3D measurement software for performing 3D measurement of the turbine blades 10 is stored in the endoscope apparatus 3.

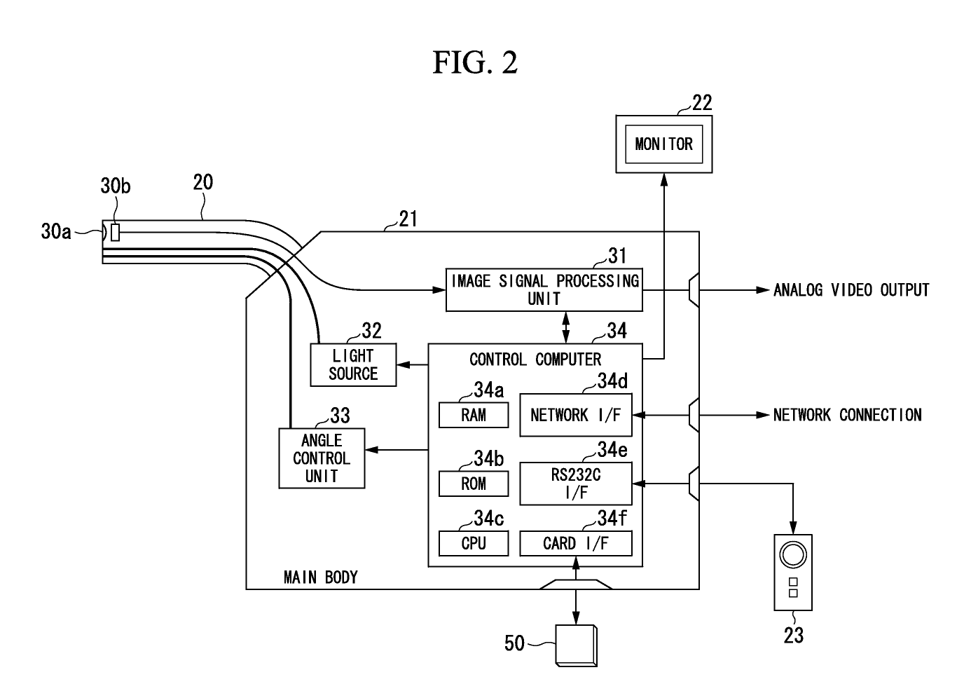

FIG. 2 illustrates a configuration of the endoscope apparatus 3. The endoscope apparatus 3 includes the endoscope insertion unit 20, a main body 21, a monitor 22, and a remote controller 23. An imaging optical system 30a and an imaging element 30b are disposed in a distal end of the insertion unit 20. In addition, an image signal processing unit (camera control unit) 31, a light source 32, an angle control unit 33, and a control computer 34 are disposed in the main body 21.

In the insertion unit 20, the imaging optical system 30a receives light from a subject (DUT), and forms an image of the subject on an imaging plane of the imaging element 30b. The imaging element 30b generates an imaging signal by photoelectrically converting the image of the subject. The imaging signal output from the imaging element 30b is input to the image signal processing unit 31.

In the main body 21, the image signal processing unit 31 converts the imaging signal from the imaging element 30b into a video signal such as a National Television System Committee (NTSC) signal, provides the video signal to the control computer 34, and further outputs the video signal to an outside as an analog video output, if necessary.

The light source 32, connected to the distal end of the insertion unit 20 through an optical fiber or the like, can irradiate light to an outside. The angle control unit 33, connected to the distal end of the insertion unit 20, can cause the distal end to be angled in an up/down/left/right direction. The light source 32 and the angle control unit 33 are controlled by the control computer 34.

The control computer 34 includes a random access memory (RAM) 34a, a read-only memory (ROM) 34b, a CPU 34c, a network interface (I/F) 34d as an external interface, a recommended standard 232 revision C (RS232C) I/F 34e, and a card I/F 34f. The RAM 34a is used to temporarily store data such as image information necessary for a software operation. The ROM 34b stores a series of software for controlling the endoscope apparatus 3, and also stores the 3D measurement software as will be described later. According to a command code of the software stored in the ROM 34b, the CPU 34c executes arithmetic operations for various control functions using the data stored in the RAM 34a.

The network I/F 34d is an interface for connecting to an external PC by a local area network (LAN) cable, and can send video information output from the image signal processing unit 31 to the external PC. The RS232C I/F 34e is an interface for connecting to the remote controller 23, and can control various operations of the endoscope apparatus 3 by allowing the user to operate the remote controller 23. The card I/F 34F can be freely attachable to or detachable from various memory cards 50, which are recording media. By mounting the memory card 50, it is possible to capture data such as image information stored in the memory card 50, or record data such as image information on the memory card 50, by control of the CPU 34c.

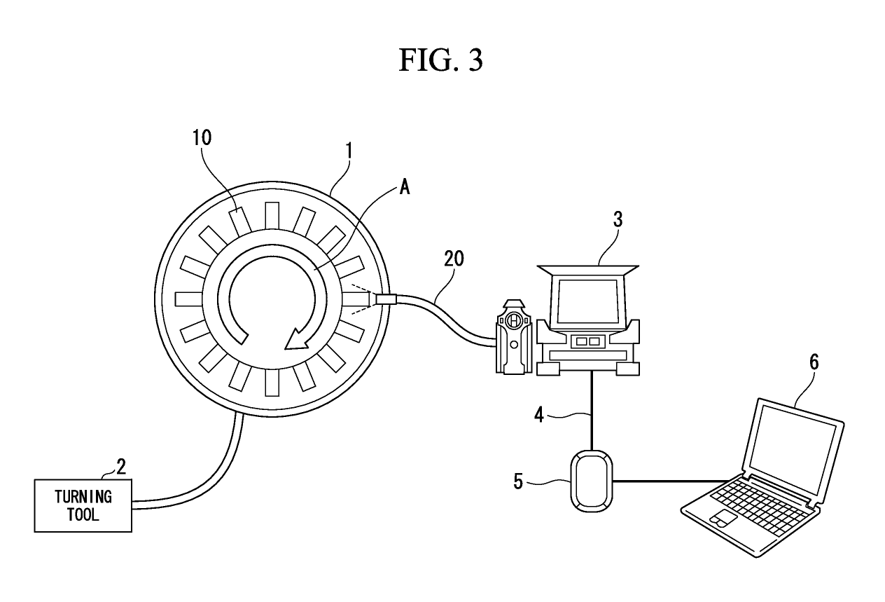

The configuration illustrated in FIG. 3 may be used as a modified example of the configuration of the blade inspection system in accordance with the first preferred embodiment. In this modified example, a video terminal cable 4 and a video capture card 5 are connected to the endoscope apparatus 3, so that the PC 6 is caused to capture a video captured by the endoscope apparatus 3. Although the PC 6 is illustrated as a notebook computer in FIG. 3, the PC 6 may be a desktop PC. The 3D measurement software for performing the 3D measurement of the turbine blades 10 is stored in the PC 6.

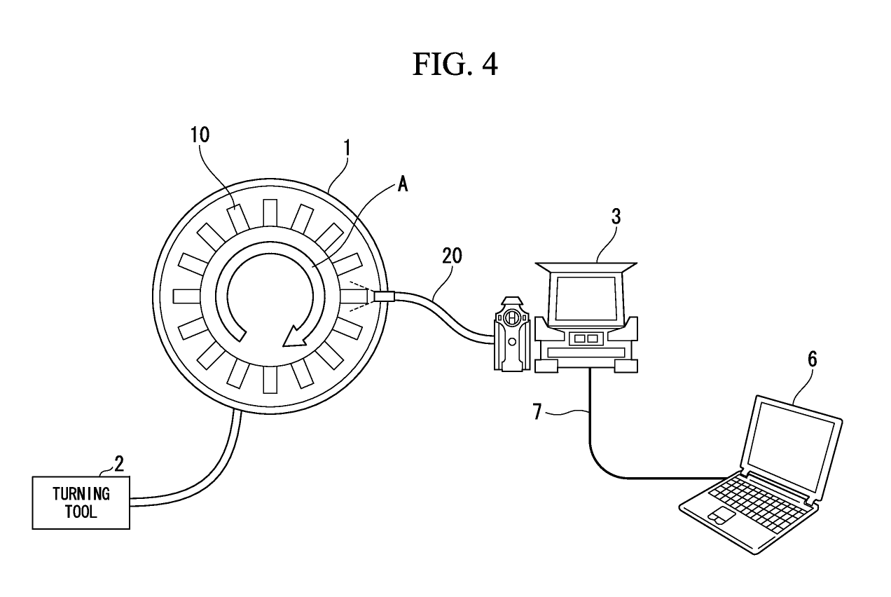

Further, although the video terminal cable 4 and the video capture card 5 are used to capture a video directed to the PC 6 in FIG. 3, the LAN cable 7 may be used as illustrated in FIG. 4. The endoscope apparatus 3 includes the network I/F 34d capable of sending the captured video to a LAN network. It is possible to cause the PC 6 to receive the video through the LAN cable 7.

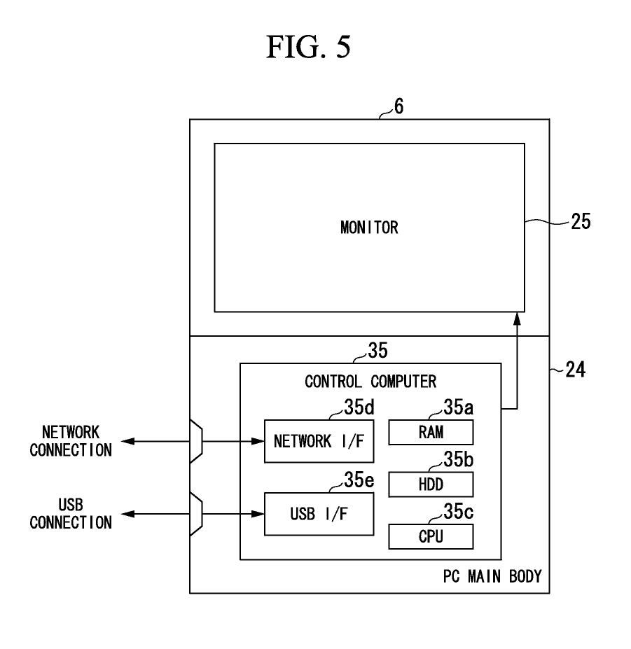

FIG. 5 illustrates a configuration of the PC 6. The PC 6 includes a PC main body 24 and a monitor 25. A control computer 35 is disposed in the PC main body 24. The control computer 35 includes a hard disk drive (HDD) 35b, a CPU 35c, a network I/F 35d as an external interface, and a universal serial bus (USB) I/F 35e. The control computer 35 is connected to the monitor 25, and causes the monitor 25 to display screens of video information and software.

The RAM 35a is used to temporarily store data such as image information necessary for a software operation. The HDD 35b stores a series of software for controlling the endoscope apparatus and also stores 3D measurement software. In addition, in the first preferred embodiment, a preservation folder, which preserves images of the turbine blades 10, is set within the HDD 35b. According to a command code of the software stored in the HDD 35b, the CPU 35c executes arithmetic operations for various control functions using the data stored in the RAM 35a.

The network I/F 35d is an interface for connecting the endoscope apparatus 3 to the PC 6 by means of the LAN cable 7, and can input video information output through the LAN from the endoscope apparatus 3 to the PC 6. The USB I/F 35e is an interface for connecting the endoscope apparatus 3 to the PC 6 by means of the video capture card 5, and can input video information output as an analog video to the PC 6.

The blade inspection systems illustrated in FIGS. 3 and 4 can have the same effect as the blade inspection system illustrated in FIG. 1. In particular, if the performance of the endoscope apparatus is inferior to that of the PC and an operation rate of the endoscope apparatus is insufficient, the blade inspection systems illustrated in FIGS. 3 and 4 may be effective.

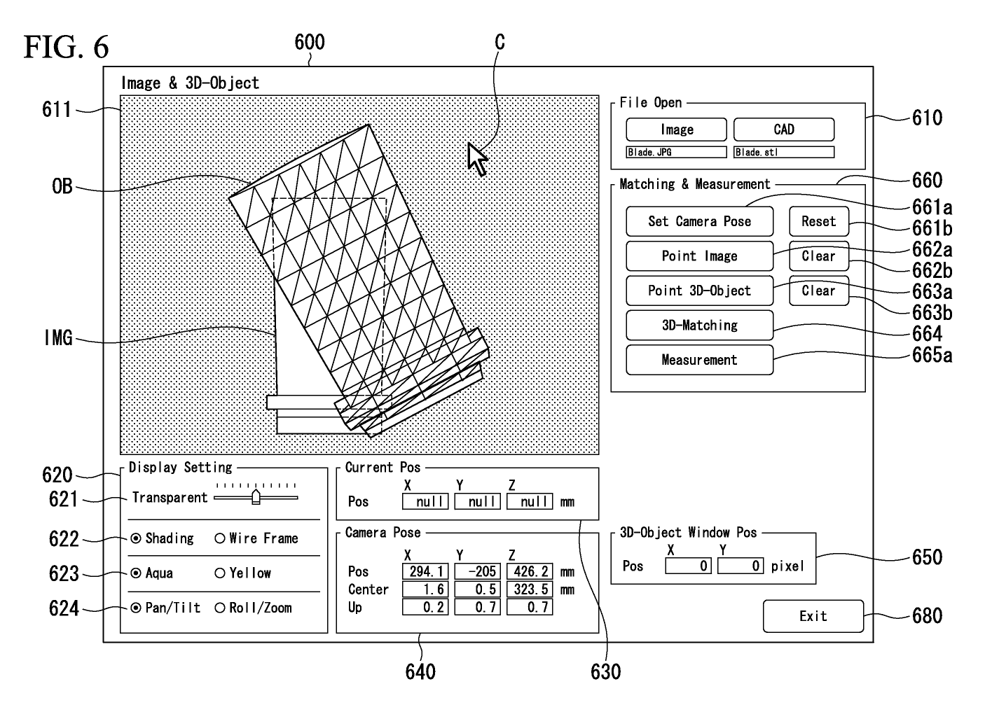

Next, a screen of the 3D measurement software will be described. FIG. 6 illustrates a main window of the 3D measurement software. The main window 600 illustrated in FIG. 6 is displayed on the monitor 22 when the user starts up the 3D measurement software. The CPU 34c performs processes based on operations of various graphical user interfaces (GUIs) within the main window 600 according to the 3D measurement software.

The main window 600 is displayed according to control by the CPU 34c. The CPU 34c generates a graphic image signal (display signal) for displaying the main window 600, and outputs the graphic image signal to the monitor 22. In addition, when a video (hereinafter referred to as a measurement image) captured by the endoscope apparatus 3 is superimposed and displayed on the main window 600, the CPU 34c performs a process of superimposing image data input from the image signal processing unit 31 on the graphic image signal, and outputs a signal (display signal) after the process to the monitor 22.

In addition, when a GUI display state on the main window 600 is updated, the CPU 34c generates a graphic image signal corresponding to the main window 600 after the update, and performs the same process as described above. A process related to a display of a window other than the main window 600 is also the same as described above. Hereinafter, a process in which the CPU 34c generates a graphic image signal to display the main window 600 or the like (also including an update) will be described as a process for displaying the main window 600 or the like.

The user operates the main window 600 via the remote controller 23 using a GUI function and moves a cursor C superimposed and displayed on the main window 600 to input an instruction such as a click, thereby performing various GUI operations of the main window 600. Hereinafter, various GUI functions will be described.

A “File Selection” or “File Open” box 610 is arranged in an upper-right portion of the main window 600. In addition, a “Measurement Image” box 611 of the main window 600 is arranged in an upper-left portion. The “File Selection” box 610 is a box for selecting a measurement image displayed in the “Measurement Image” box 611 and selecting computer-aided design (CAD) data corresponding to a 3D object displayed in the “Measurement Image” box 611.

The CAD data is data indicating a 3D shape of the turbine blades 10 pre-calculated using a CAD. The format of standard triangulated language (STL) or the like is used as the format of CAD data. The 3D object is an object of CG constructed along with content of the CAD data. Details of GUIs and operations within the [File Selection] box 610 will not be described.

The “Measurement Image” box 611 is a box for displaying a measurement image IMG acquired by imaging the turbine blades 10, which are measurement targets, and superimposing and displaying an image of a 3D object OB on the measurement image IMG. As will be described later, the user changes a camera pose and designates reference points by operating the “Measurement Image” box 611.

A “Display Setting” box 620 is arranged in a lower-left portion of the main window 600. GUIs related to display settings of the 3D object OB displayed in the “Measurement Image” box 611 are arranged within the “Display Setting” box 620. Functions of the GUIs within the “Display Setting” box 620 are as follows.

A “Transparent” bar 621 is used to set display transparency of the 3D object. The “Transparent” bar 621 can move (slide) in a horizontal direction (lateral direction). The user varies the display transparency of the 3D object by moving the “Transparent” bar 621.

For example, if the transparency is set high, the 3D object OB is displayed with being made nearly transparent. If the transparency is set low, the 3D object OB is displayed without being made transparent. As will be described later, when the user designates reference points on the measurement image IMG in the “Measurement Image” box 611, it is preferable that the transparency of the 3D object OB be set high so that the measurement image IMG is easily viewable. In addition, when the user designates reference points on the 3D object OB, it is preferable that the transparency of the 3D object OB be set low so that the 3D object OB is easily viewable.

A “Display Method” radio button 622 is a radio button for setting a display method of the 3D object OB. There are two setting items of “Shading” and “Wire Frame” in the “Display Method” radio button 622. If “Shading” has been selected, the 3D object OB is displayed in a state in which the wire frame and the surface are painted out. If “Wire Frame” has been selected, the 3D object OB is displayed only in a wire frame state as illustrated in FIG. 6.

A “Display Method” radio button 623 is a radio button for setting a display color of the 3D object OB. There are two setting items of “Aqua” and “Yellow” in the “Display Method” radio button 623. According to settings of the “Display Method” radio button 623, it is possible to switch the display color of the 3D object OB.

A “Moving Direction” radio button 624 is a radio button for setting a moving direction of the camera pose. The camera pose is a parameter indicating a pose of the 3D object OB, that is, a direction and a position in which the 3D object OB is viewed. In other words, the camera pose is a parameter indicating the pose of an ideal camera (hereinafter referred to as a virtual camera) imaging the 3D object OB. There are two setting items of “Pan/Tilt” and “Roll/Zoom” in the “Moving Direction” radio button 624. If “Pan/Tilt” has been selected, the user can rotate the camera pose in the pan/tilt direction by moving the cursor C in the up/down/left/right direction in the “Measurement Image” box 611. In addition, if “Roll/Zoom” has been selected, it is possible to rotate the camera pose in the roll/zoom direction with the same operation.

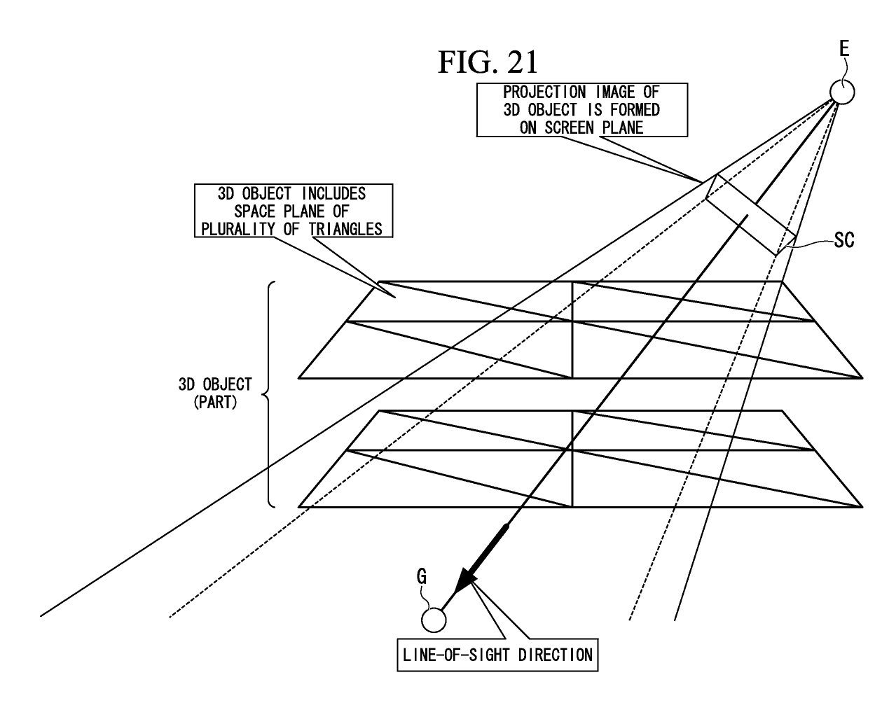

Below the “Measurement Image” box 611, a “Current Position (Pos)” box 630 is arranged. The “Current Pos” box 630 is a box for displaying surface coordinates of the 3D object OB in a cursor position in real time. The surface coordinates of the 3D object are displayed in units of mm as coordinates of a three-dimensional coordinate system. In the “Measurement Image” box 611, the user also changes a value of the “Current Pos” box 630 in real time by moving the cursor C. For example, if the cursor C is positioned on the 3D object OB, the surface coordinates of the 3D object OB are calculated and displayed in the “Current Pos” box 630. If the cursor C is not positioned on the 3D object OB, the “Current Pos” box 630 is displayed as “null.” A method of calculating the surface coordinates of the 3D object OB will be described later using FIGS. 21 to 24.

Below the “Current Pos” box 630, the “Camera Pose” box 640 is arranged. The “Camera Pose” box 640 is a box for displaying the camera pose in real time. The user changes the camera pose, so that a value of the “Camera Pose” box 640 is changed in real time. The camera pose is displayed in units of mm as coordinates of the three-dimensional coordinate system.

On the right of the “Camera Pose” box 640, a “3D-Object Window Pos” box 650 is arranged. The “3D-Object Window Pos” box 650 is a box for displaying a shift position of the 3D object OB in the “Measurement Image” box 611. The shift position of the 3D object OB is displayed in units of pixels as coordinates of a plane coordinate system.

The 3D object OB is displayed on the center of the “Measurement Image” box 611, and a display position does not change even when the camera pose changes. However, a DUT imaged in the measurement image IMG is not necessarily positioned on the center of the image. Thus, after execution of a 3D matching process, which is a process of matching the measurement image IMG and the 3D object OB, the 3D object OB should be positioned on the DUT imaged in the measurement image, not on the center of the “Measurement Image” box 611.

The above-described shift position indicates a relative position of the 3D object OB from the center of the “Measurement Image” box 611. Hereinafter, the moving direction of the shift position in the plane coordinate system is referred to as a shift direction. The user is unable to manually change the shift position at his or her discretion. The shift position is calculated by the CPU 34c after the 3D matching process is executed.

Below the “File Selection” box 610, a “Matching & Measurement” box 660 is arranged. Within the “Matching & Measurement” box 660, GUIs related to the 3D matching process and the measurement are arranged. GUI functions within the “Matching & Measurement” box 660 are as follows.

A “Camera Pose” or “Set Camera Pose” button 661a is a button for changing the camera pose. After the “Camera Pose” button 661a is actuated, the user can change the camera pose by moving the cursor C in the up/down/left/right direction in the “Measurement Image” box 611. In addition, a “Reset” button 661b is arranged on the right of the “Camera Pose” button 661a. If the “Reset” button 661b is actuated, the camera pose is set to the initial value.

The “Reference Point (Measurement)” or “Point Image” button 662a is a button for designating a reference point (measurement) of the measurement image IMG. The reference point (measurement) is a point on the measurement image IMG serving as a standard when the CPU 34c executes the 3D matching process. After the “Reference Point (Measurement)” button 662a is actuated, the user can designate the reference point (measurement) for the DUT imaged in the measurement image IMG by moving the cursor C and performing a click or the like in a desired designation position in the “Measurement Image” box 611. The reference point (measurement) is indicated in units of pixels as coordinates of the plane coordinate system. In addition, if the “Reference Point (Measurement)” button 662a is actuated, the display transmittance of the 3D object OB is automatically set high, so that the measurement image is in an easy-to-view state. In addition, on the right of the “Reference Point (Measurement)” button 662a, a “Clear” button 662b is arranged. If the “Clear” button 662b is actuated, already designated reference points (measurement) are all cleared and the state before the designation is reached.

A “Reference Point (3D)” or “Point 3D-Object” button 663a is a button for designating a reference point (3D) of the 3D object OB. Like the reference point (measurement), the reference point (3D) is a point on the 3D object serving as a standard when the CPU 34c executes the 3D matching process. After the “Reference Point (3D)” button 663a is actuated, the user can designate the reference point (3D) for the 3D object OB by moving the cursor C and performing an operation such as a click in a position at which the reference point (3D) is desired to be designated in the “Measurement Image” box 611. The reference point (3D) is displayed in units of mm as coordinates of the three-dimensional coordinate system. In addition, after the “Reference Point (3D)” button 663a is actuated, the display transmittance of the 3D object OB is automatically set low, so that the measurement image is in an easy-to-view state. In addition, a “Clear” button 663b is arranged on the right of the “Reference Point (3D)” button 633a. If the “Clear” button 663b is actuated, already designated reference points (3D) are all cleared and a state before the designation is reached.

A “3D-Matching” button 664 is a button for executing the 3D matching process. After the “3D-Matching” button 664 is actuated, the CPU 34c executes the 3D matching process based on two pairs of reference points (measurement) and reference points (3D) designated by the user. At this time, the CPU 34c performs the 3D matching process so that positions of the two pairs of reference points are substantially consistent. As a result of the 3D matching process, the DUT within the measurement image IMG and the 3D object OB are displayed to be substantially consistent. The DUT within the measurement image IMG and the 3D object OB are in a state suitable for measurement.

A “Measurement” button 665a is a button for performing a measurement process. After the “Measurement” button 665a is actuated, a measurement window is displayed as will be described later, and the measurement process for the 3D object OB can be performed.

In the lower-right portion of the main window 600, an “Exit” button 680 is arranged. The “Exit” button 680 is a button for ending the 3D measurement software. If the “Exit” button 680 is actuated, all software operations end and the main window 600 is closed (and is not displayed).

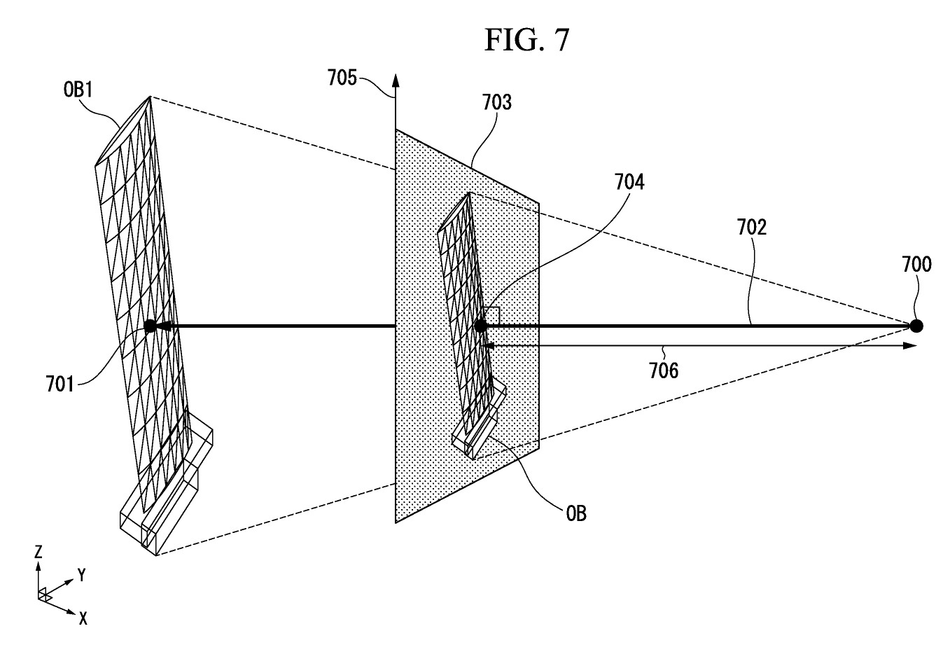

Next, the relationship between the 3D object and the camera pose will be described using FIG. 7. As illustrated in FIG. 7, a 3D object OB1 and a view point 700 are on a virtual space corresponding to a real space. Although the position of the 3D object OB1 is fixed, the position of the view point 700 is freely changed by the user. A line-of-sight center 701 is in a center position of the 3D object OB1 and a line extending from the view point 700 to a line-of-sight direction 702 is constantly directed to the line-of-sight center 701. A position of the line-of-sight center 701 is fixed. The view point 700 corresponds to a position of a virtual camera imaging the 3D object OB1, and the line-of-sight direction 702 corresponds to an imaging direction (optical-axis direction) of the virtual camera.

There is a screen plane 703, which is a rectangular virtual plane, between the 3D object OB1 and the view point 700. The screen plane 703 corresponds to the “Measurement Image” box 611. Sizes of vertical and horizontal directions of the screen plane 703 have fixed values. A projection image obtained by projecting the 3D object OB1 on the screen plane 703 is the 3D object OB displayed in the “Measurement Image” box 611.

The screen plane 703 is constantly perpendicular to the line-of-sight direction 702, and the straight line extending from the view point 700 to the line-of-sight direction 702 constantly passes through a center 704 of the screen plane 703. Although a distance 706 from the view point 700 to the center 704 of the screen plane 703 has a fixed value, the distance from the view point 700 to the line-of-sight center 701 is freely changed by the user.

A direction of the screen plane 703 is indicated by an upward vector 705. The upward vector 705 is parallel to the screen plane 703, and is a unit vector indicating which direction is an upward direction of the screen plane 703.

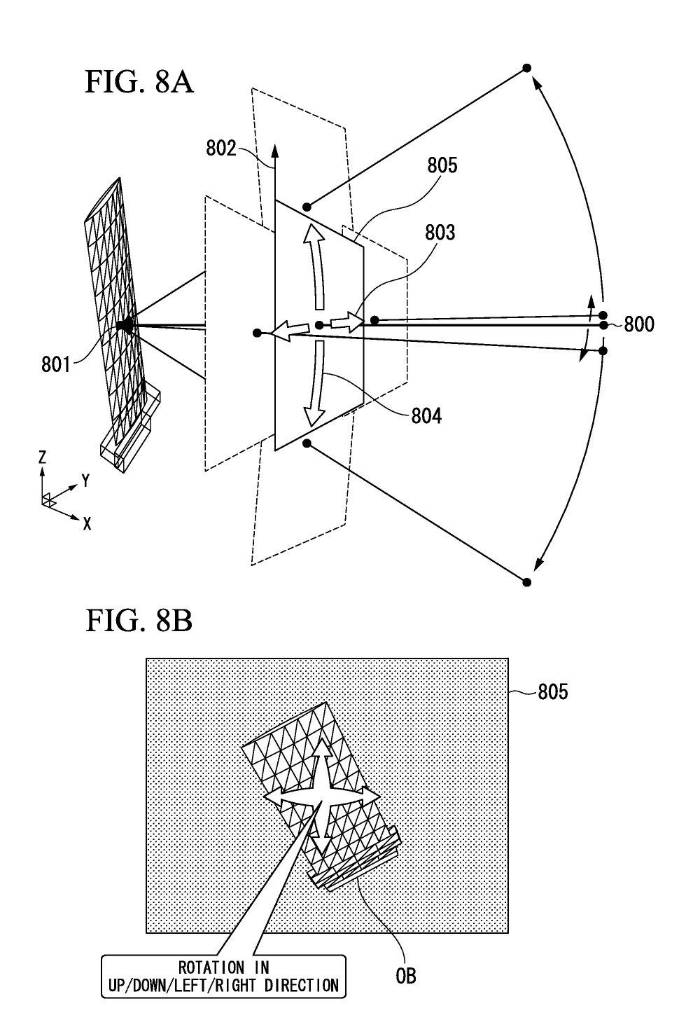

Among items illustrated in FIG. 7, parameters constituting the camera pose are three of a point-of-view position, a line-of-sight center position, and an upward vector. Hereinafter, the relationship between the 3D object and the camera pose when the camera pose changes will be described using FIGS. 8A to 10B.

FIG. 8A illustrates the relationship between the 3D object and the camera pose when the camera pose changes in a pan/tilt direction. The pan direction is a direction (pan direction 803) in which a view point 800 moves perpendicular to an upward vector 802 while a distance from the view point 800 to a line-of-sight center 801 is fixed. The tilt direction is a direction (tilt direction 804) in which the view point 800 moves parallel to the upward vector 802 while the distance from the view point 800 to the line-of-sight center 801 is fixed. It can be seen that the 3D object OB projected on the screen plane 805 rotates in each direction of the up/down/left/right directions as illustrated in FIG. 8B when the camera pose changes in the pan/tilt direction as illustrated in FIG. 8A.

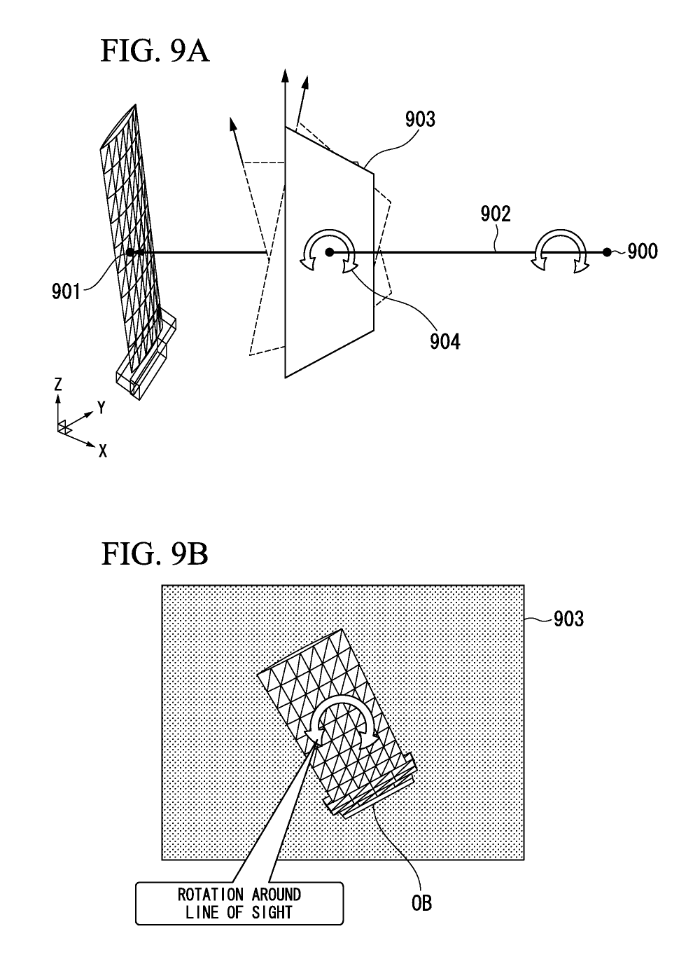

FIG. 9A illustrates the relationship between the 3D object and the camera pose when the camera pose changes in a roll direction. The roll direction is a direction (roll direction 904) in which a screen plane 903 rotates around the axis of a line-of-sight direction 902 from a view point 900 to a point-of-view center 901 while a position of the view point 900 is fixed. It can be seen that the 3D object OB projected on the screen plane 903 rotates using the center of the screen plane 903 as the axis as illustrated in FIG. 9B when the camera pose changes in the roll direction as illustrated in FIG. 9A.

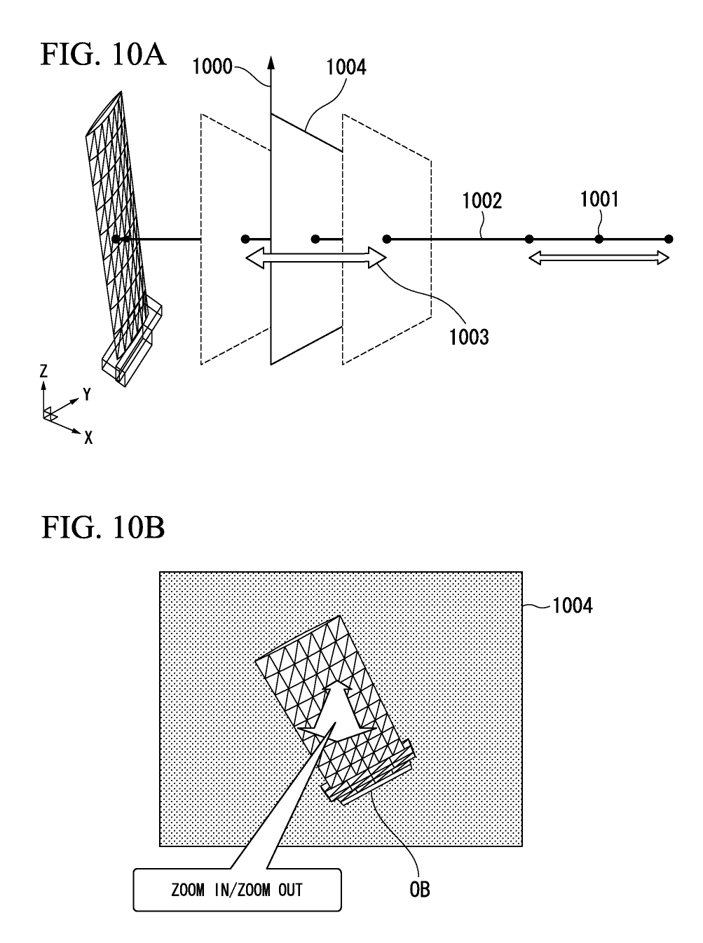

FIG. 10A illustrates the relationship between the 3D object and the camera pose when the camera pose changes in a zoom direction. The zoom direction is a direction (zoom direction 1003) in which a view point 1001 moves parallel to a line-of-sight 1002 while an upward vector 1000 is fixed. It can be seen that the 3D object projected on a screen plane 1004 is zoomed in/zoomed out as illustrated in FIG. 10B when the camera pose changes in the zoom direction as illustrated in FIG. 10A.

As described above, a position/direction of the screen plane varies if the camera pose changes. Accordingly, the display of the 3D object projected on the screen plane also varies. As a result, the display of the 3D object displayed in the “Measurement Image” box 611 also varies. The CPU 34c performs a process of detecting a camera-pose change instruction input by the user via the remote controller 23 and displaying the 3D object in the “Measurement Image” box 611 according to the change instruction.

Next, a flow of a 3D measurement software operation will be described. Hereinafter, only operations related to some GUI-related operations, not all GUI-related operations, in the main window 600 will be described. Specifically, operations related to the “Measurement Image” box 611, the “Camera Pose” button 661a, the “Reference Point” button 662a, the “Reference Point (3D)” button 663a, the “3D-Matching” button 664, the “Measurement” button 665a, and the “Exit” button 680 will be described. However, other GUI-related operations will not be described.

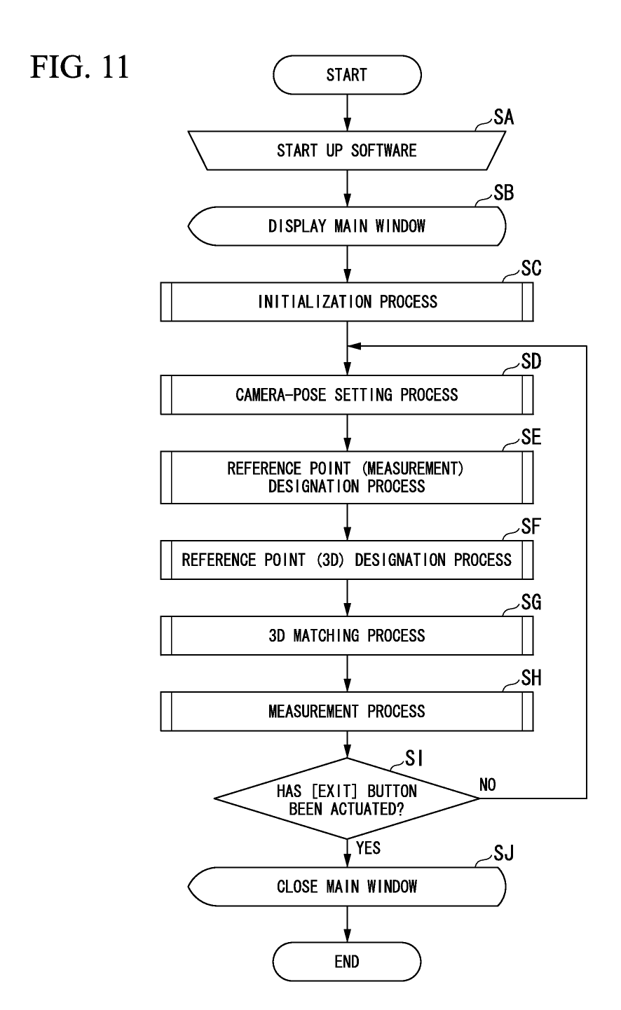

FIG. 11 illustrates the flow of the 3D measurement software operation. In step SA, the CPU 34c starts up 3D measurement software. Specifically, the CPU 34c reads the 3D measurement software stored in the ROM 34b to the RAM 34a based on a start-up instruction input by the user via the remote controller 23, and starts an operation according to the 3D measurement software. In step SB, the CPU 34c performs a process of displaying the main window 600.

In step SC, the CPU 34c performs an initialization process. The initialization process is a process of setting initial states of various GUIs within the main window 600 or setting initial values of various data recorded on the RAM 34a. Details of the initialization process will be described later.

In step SD, the CPU 34c performs a camera-pose setting process. The camera-pose setting process is a process of roughly matching the DUT and the 3D object within the measurement image of the “Measurement Image” box 611 based on an instruction for changing the camera pose input by the user. Details of the camera-pose setting process will be described later.

In step SE, the CPU 34c performs a reference point (measurement) designation process. The reference point (measurement) designation process is a process of designating (setting) a reference point based on an instruction for designating a position on the DUT imaged in the measurement image of the “Measurement Image” box 611 input by the user. Details of the reference point (measurement) designation process will be described later.

In step SF, the CPU 34C performs a reference point (3D) designation process. The reference point (3D) designation process is a process of designating (setting) a reference point based on an instruction for designating a position on the 3D object of the “Measurement Image” box 611 input by the user.

In step SG, the CPU 34c performs a 3D matching process. The 3D matching process is a process of matching the measurement image and the 3D object displayed in the “Measurement Image” box 611 based on two pairs of reference points (reference points (measurement) and reference points (3D)) designated by the user. Details of the 3D matching process will be described later.

In step SH, the CPU 34c performs a measurement process. The measurement process is a process of designating (setting) a reference point based on an instruction for designating a position on the 3D object of the “Measurement Image” box 611 and calculating the size of the DUT based on the designated reference point. Details of the measurement process will be described later.

In step S1, the CPU 34c checks whether or not the user has actuated the “Exit” button 680. If the user has actuated the “Exit” button 680, the process moves to step SJ. In addition, if the user has not actuated the “Exit” button 680, the process moves to step SD. In step SJ, the CPU 34c does not display the main window 600 and ends the operation of the 3D measurement software.

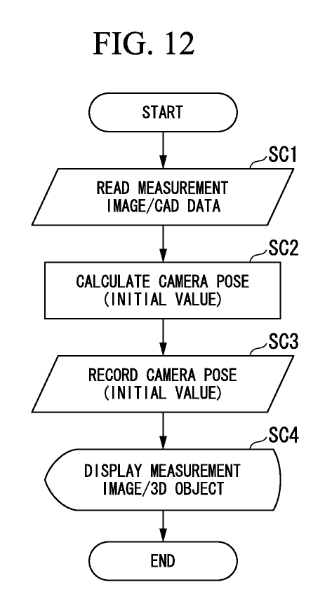

Next, a flow of the operation of the initialization process of step SC will be described using FIG. 12. In step SC1, the CPU 34c reads a predetermined measurement image file and CAD data recorded on the memory card 50 to the RAM 34a. In step SC2, the CPU 34c calculates the camera pose (initial pose) based on the read CAD data.

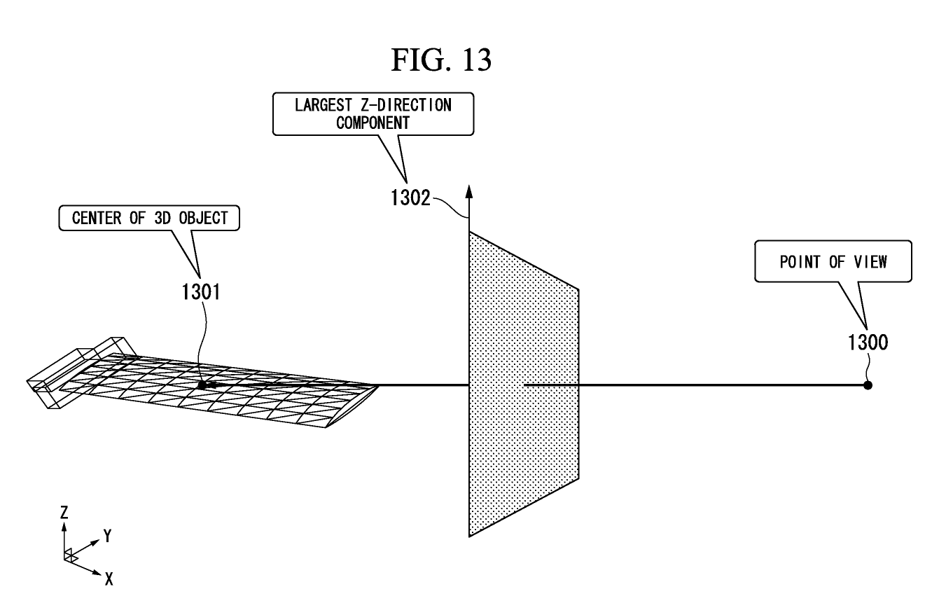

In terms of the point-of-view position in the camera pose, as illustrated in FIG. 13, the CPU 34c designates coordinates (x, y, z)=(0, 0, 0) of the view point as an initial value (view point 1300). In terms of the line-of-sight center position in the camera pose, as illustrated in FIG. 13, the CPU 34c calculates a center position of all three-dimensional coordinates in the CAD data, and designates its coordinates as an initial value (point-of-view center 1301). The line-of-sight center position is a unique value for each piece of CAD data. Thereafter, the value does not vary even when the camera pose changes. In terms of the upward vector in the camera pose, as illustrated in FIG. 13, a unit vector parallel to a vertical side of the screen plane among unit vectors perpendicular to a line connected to the view point 1300 and the line-of-sight center 1301 is designated as an initial value (upward vector 1302).

In step SC3, the CPU 34c records a camera pose (initial pose) calculated in step SC2 as a current camera pose on the RAM 34a. The current camera pose is a currently set camera pose, and the 3D object is displayed based on the current camera pose.

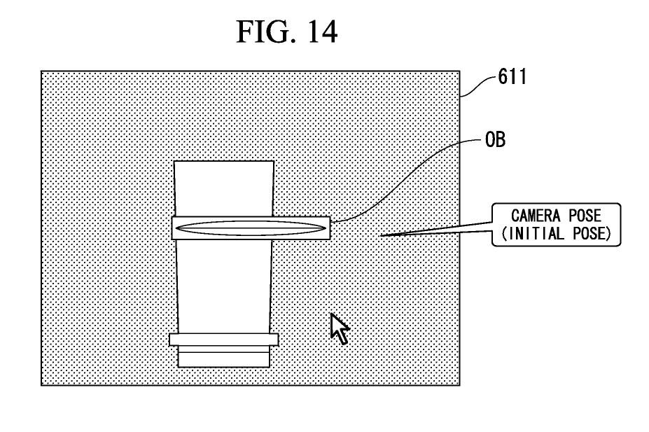

In step SC4, the CPU 34c executes a process of displaying the measurement image IMG, and further superimposing and displaying the 3D object OB thereon at predetermined transparency in the “Measurement Image” box 611 as illustrated in FIG. 14. At this time, the 3D object OB is displayed as a plan view projected on the screen plane based on the calculated camera pose (initial pose). If the process of step SC4 ends, the initialization process ends.

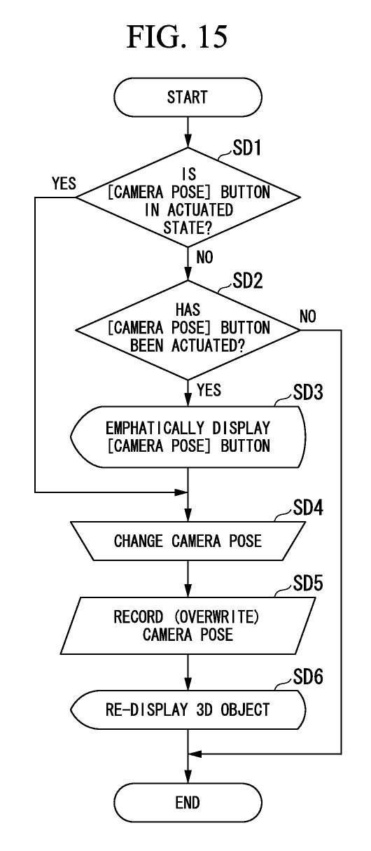

Next, a flow of the camera-pose setting process of step SD will be described using FIG. 15. In step SD1, the CPU 34c checks whether or not the “Camera Pose” button 661a has already been actuated (in a state in which the process of step SD3 has already been performed). If the “Camera Pose” button 661a is in the actuated state, the process moves to step SD4. If the “Camera Pose” button 661a is not in the actuated state, the process moves to step SD2.

In step SD2, the CPU 34c checks whether or not the user has actuated the “Camera Pose” button 661a. If the “Camera Pose” button 661a has been actuated, the process moves to step SD3. If the “Camera Pose” button 661a has not been actuated, the camera-pose setting process ends.

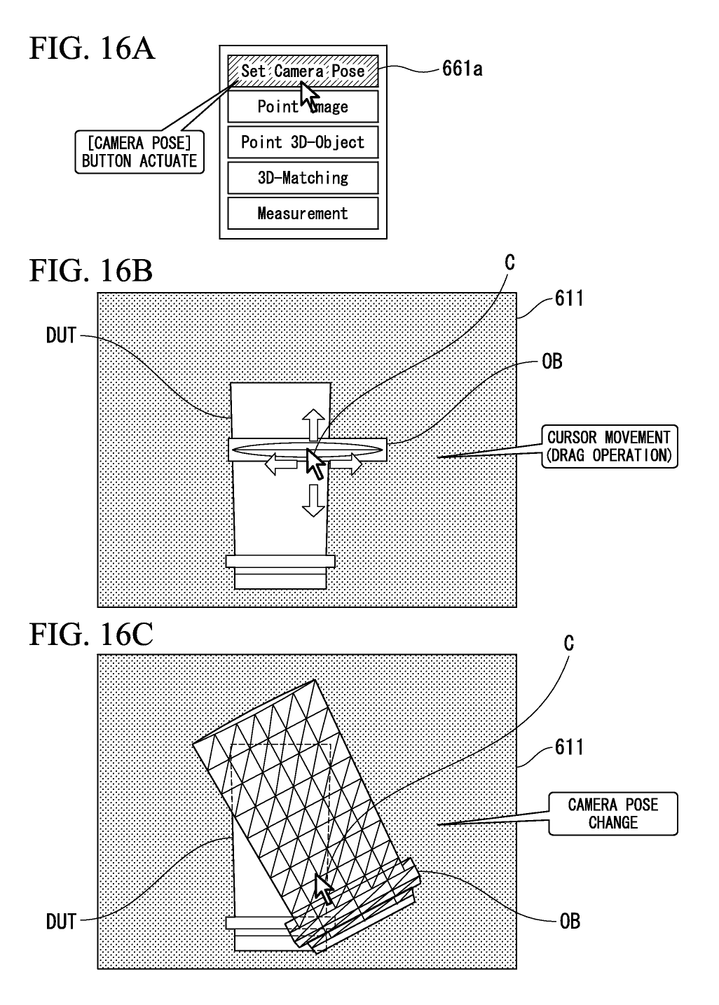

In step SD3, the CPU 34c performs a process of emphatically displaying the “Camera Pose” button 661a as illustrated in FIG. 16A. The process of emphatically displaying the “Camera Pose” button 661a is used to notify the user that the camera pose is currently changeable.

In step SD4, as illustrated in FIG. 16B, the CPU 34c detects an operation (drag operation) for moving the cursor C while the user operates the remote controller 23 to perform a click or the like by means of the cursor C in the “Measurement Image” box 611, and changes the camera pose based on a result of detection of the operation of the cursor C. At this time, the user changes the camera pose so that the DUT and the 3D object OB imaged in the measurement image roughly match. The camera pose is changeable in the pan/tilt/roll/zoom direction described above. In addition, at this time, the CPU 34c detects an operation instruction of the cursor C input via the remote controller 23, and calculates the camera pose after the change based on the operation instruction.

In step SD5, the CPU 34c overwrites and records the camera pose after the change on the RAM 34a as a current camera pose. In step SD6, the CPU 34c performs a process of re-displaying the 3D object based on the current camera pose. Thereby, as illustrated in FIG. 16C, the 3D object OB for which the camera pose has changed is displayed in the “Measurement Image” box 611. If the process of step SD6 ends, the camera-pose setting process ends.

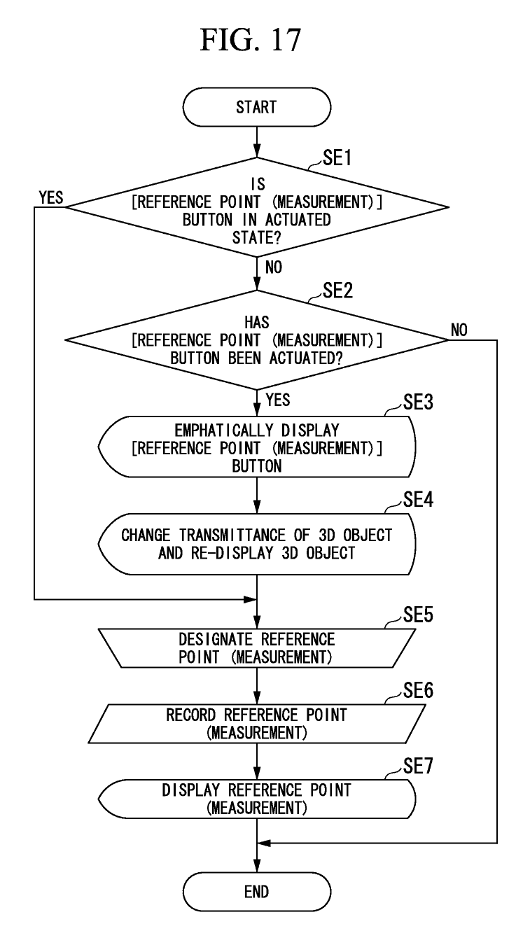

Next, a flow of the reference point (measurement) designation process of step SE will be described using FIG. 17. In step SE1, the CPU 34c checks whether or not the “Reference Point (Measurement)” button 662a has already been actuated (in a state in which the process of steps SE3 and SE4 has already been performed). If the “Reference Point (Measurement)” button 662a has been actuated, the process moves to step SE5. If the “Reference Point (Measurement)” button 662a has not been actuated, the process moves to step SE2.

In step SE2, the CPU 34c checks whether or not the user has actuated the “Reference Point (Measurement)” button 662a. If the “Reference Point (Measurement)” button 662a has been actuated, the process moves to step SE3. If the “Reference Point (Measurement)” button 662a has not been actuated, the reference point (measurement) designation process ends.

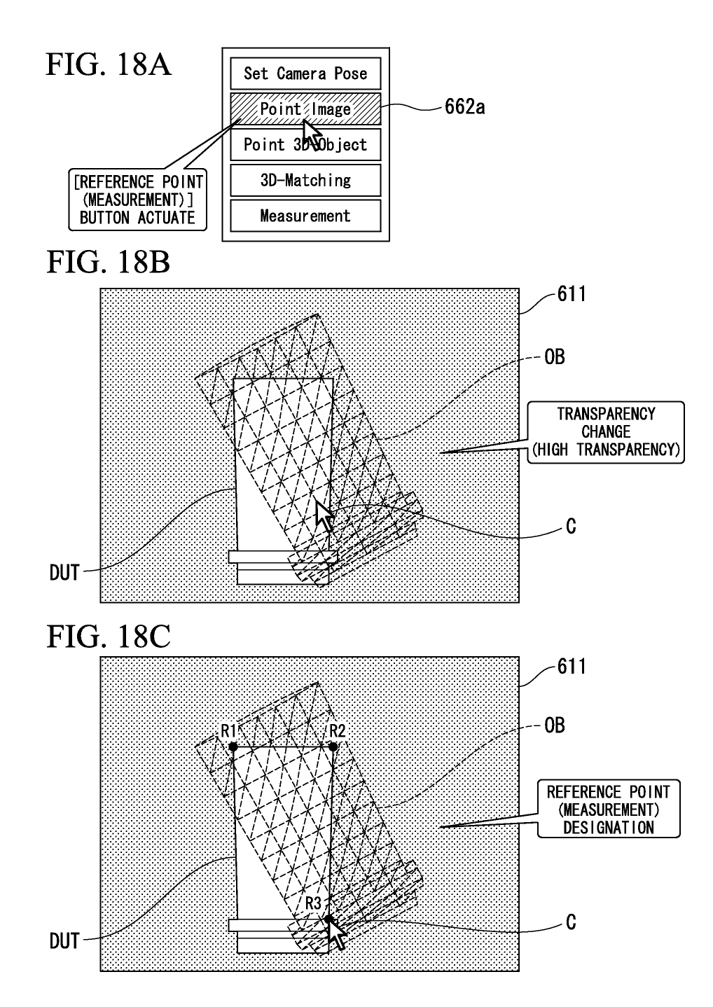

In step SE3, the CPU 34c performs a process of emphatically displaying the “Reference Point (Measurement)” button 662a as illustrated in FIG. 18A. The process of emphatically displaying the “Reference Point (Measurement)” button 662a is used to notify the user that the reference point can be currently designated for the measurement image.

In step SE4, the CPU 34c performs a process of changing the transparency of the 3D object OB and re-displaying the 3D object OB at the changed transparency as illustrated in FIG. 18B. Here, a value of the set transparency is large, the 3D object OB is made nearly transparent, and the measurement image is in an easy-to-view state. Although not separately illustrated, the 3D object is not temporarily displayed if the designated reference point (3D) is already exists. This is also to enable the measurement image to be in the easy-to-view state.

In step SE5, the CPU 34c detects an operation in which the user performs a click or the like by means of the cursor C by operating the remote controller 23 so as to designate the reference point (measurement) for the DUT imaged in the measurement image in the “Measurement Image” box 611, and calculates coordinates of the designated reference point based on a detection result of the operation of the cursor C. At this time, the calculated coordinates of the reference point (measurement) are plane coordinates (in units of pixels) in the measurement image.

In step SE6, the CPU 34c records coordinates of the designated reference point (measurement) on the RAM 34a. In step SE7, the CPU 34c performs a process of superimposing and displaying the designated reference point (measurement) on the measurement image. Thereby, reference points (measurement) R1, R2, and R3 are superimposed and displayed on the measurement image as illustrated in FIG. 18C. If the process of step SE7 ends, the reference point (measurement) designation process ends.

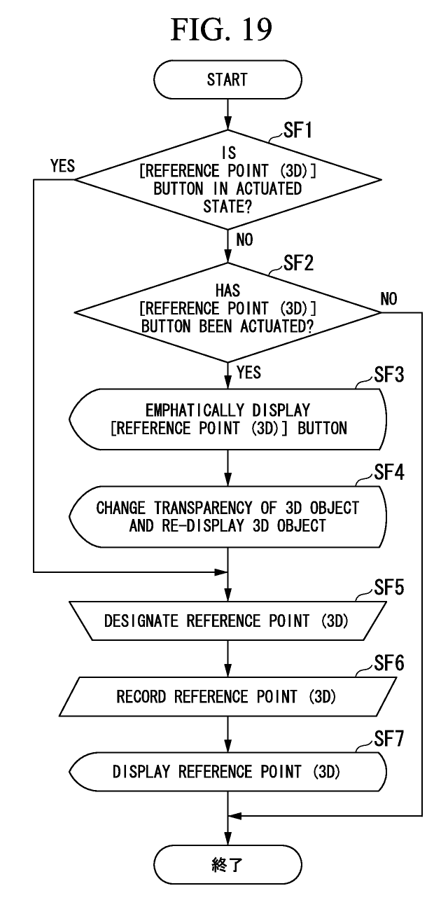

Next, a flow of the reference point (measurement) designation process of step SF will be described using FIG. 19. In step SF1, the CPU 34c checks whether or not the “Reference Point (3D)” button 663a has already been actuated (in a state in which the process of steps SF3 and SF4 has already been performed). If the “Reference Point (3D)” button 663a has been actuated, the process moves to step SF5. If the “Reference Point (3D)” button 663a has not been actuated, the process moves to step SF2.

In step SF2, the CPU 34c checks whether or not the user has actuated the “Reference Point (3D)” button 663a. If the “Reference Point (Measurement)” button 663a has been actuated, the process moves to step SF3. If the “Reference Point (3D)” button 663a has not been actuated, the reference point (3D) designation process ends.

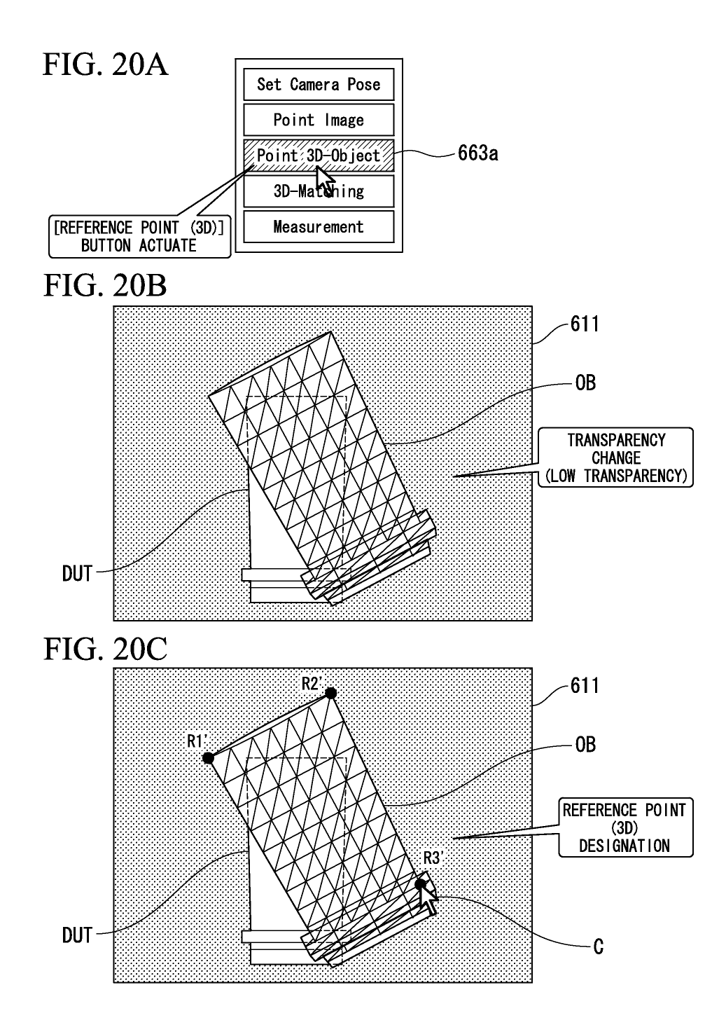

In step SF3, the CPU 34c performs a process of emphatically displaying the “Reference Point (3D)” button 663a as illustrated in FIG. 20A. The process of emphatically displaying the “Reference Point (3D)” button 663a is used to notify the user that the reference point can be currently designated for the 3D object.

In step SF4, the CPU 34c performs a process of changing the transparency of the 3D object OB and re-displaying the 3D object OB at the changed transparency as illustrated in FIG. 20B. Here, a value of the set transparency is small, and the 3D object OB is in an easy-to-view state. At this time, although not separately illustrated, the measurement image is not temporarily displayed when there is the already designated reference point (measurement). This is also to enable the 3D object OB to be in the easy-to-view state.

In step SF5, the CPU 34c detects an operation in which the user performs a click or the like by means of the cursor C by operating the remote controller 23 so as to designate the reference point (3D) for the DUT imaged in the measurement image in the “Measurement Image” box 611, and calculates coordinates of the designated reference point based on a result of detection of the operation of the cursor C. At this time, the calculated reference point (3D) coordinates are three-dimensional coordinates in the 3D object surface (in units of mm). The CPU 34c calculates plane coordinates of the first designated reference point (in units of pixels), and then calculates three-dimensional coordinates (in units of mm) from the calculated plane coordinates.

Reference points (3D) designated by the user should be associated with already designated reference points (measurement). In the first preferred embodiment, the CPU 34c associates the reference points (3D) with the reference points (measurement) based on the order in which the user has designated the reference points (measurement) and the order in which the reference points (3D) have been designated. More specifically, the CPU 34c associates a first designated point of the reference points (measurement) with a first designated point of the reference points (3D), associates a second designated point of the reference points (measurement) with a second designated point of the reference points (3D), . . . , and associates an n-th designated point of the reference points (measurement) with an n-th designated point of the reference points (3D). The above-described method is an example, and the present invention is not limited thereto.

As illustrated in FIG. 18C, an upper-left reference point (measurement) R1, an upper-right reference point (measurement) R2, and a lower-right reference point (measurement) R3 of the DUT are designated. After the designation of the reference points (measurement) has ended, the user designates the reference points (3D) on the 3D object OB corresponding to the reference points (measurement) on the DUT in the same order as when the reference points (measurement) were designated. As illustrated in FIG. 20C, reference points (measurement) R1′ R2′, and R3′ are designated in positions on the 3D object corresponding to the reference points (measurement) R1, R2, and R3 on the DUT.

In step SF6, the CPU 34c records coordinates of a designated reference point (3D) on the RAM 34a. In step SF7, the CPU 34c performs a process of superimposing and displaying the designated reference points (3D) on the 3D object. Thereby, as illustrated in FIG. 20C, the reference points (3D) R1′, R2′, and R3′ are superimposed and displayed on the 3D object OB. If the process of step SF7 ends, the reference point (3D) designation process ends.

The CPU 34c may record coordinates of the designated reference points (3D) in CAD data or another file associated with the CAD data. Thereby, if the same CAD data has been read again in step SC1, the process of steps SF1 to SF5 can be omitted. In addition, the reference points (3D) are not necessarily designated in step SF, but may be recorded in advance in CAD data by the endoscope apparatus 3 or the PC 6 or may be recorded on another file associated with CAD data.

Next, a method of calculating three-dimensional coordinates (3D coordinates) on a 3D object surface of a designated reference point (3D) will be described using FIGS. 21 to 24. FIG. 21 illustrates the relationship between part of the 3D object in a 3D space and a view point E.

The 3D object includes three-dimensional planes of a plurality of triangles. A direction from the view point E to a center point G of the 3D object becomes a line-of-sight direction. A screen plane SC perpendicular to the line-of-sight direction is set between the view point E and the 3D object.

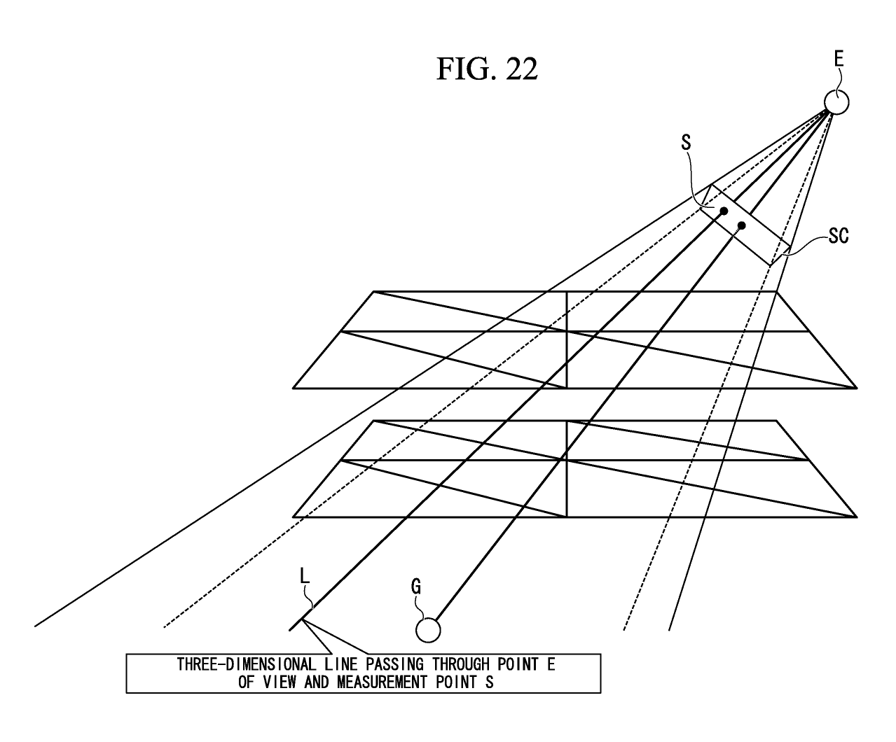

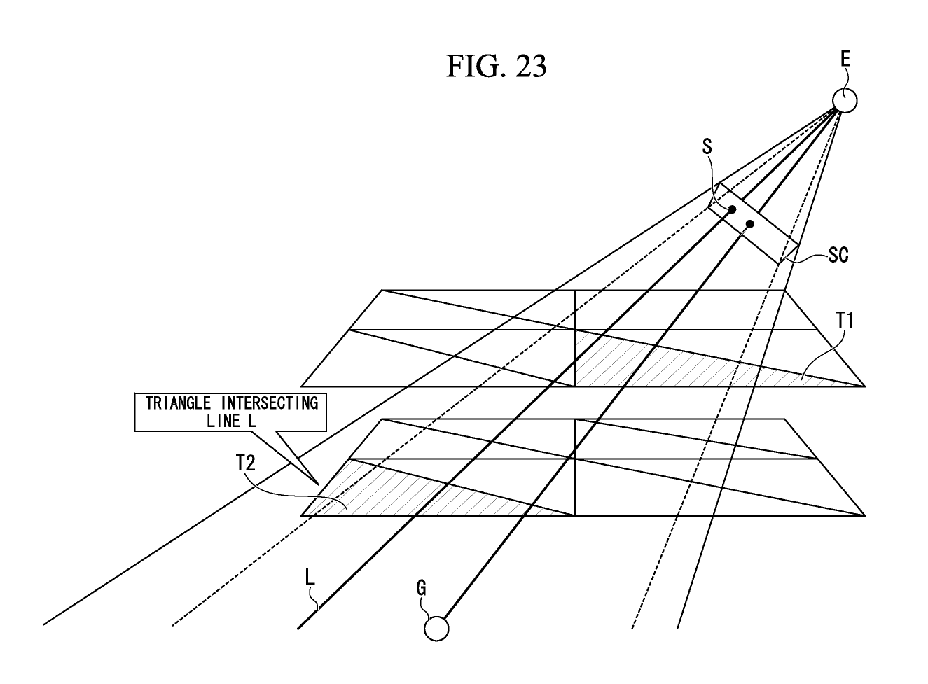

If the user designates the reference point (3D) on the 3D object in the “Measurement Image” box 611, the CPU 34c sets a reference point S on the screen plane SC as illustrated in FIG. 22. A three-dimensional line passing through the reference point S and the view point E is designated as a line L. The CPU 34c searches for all triangles intersecting the line L from among a plurality of triangles constituting the 3D object. As a method of determining whether or not the line intersects the three-dimensional triangle, for example, Tomas Moller's intersection determination method can be used. In this example, triangles T1 and T2 are determined to be triangles intersecting the line L as illustrated in FIG. 23.

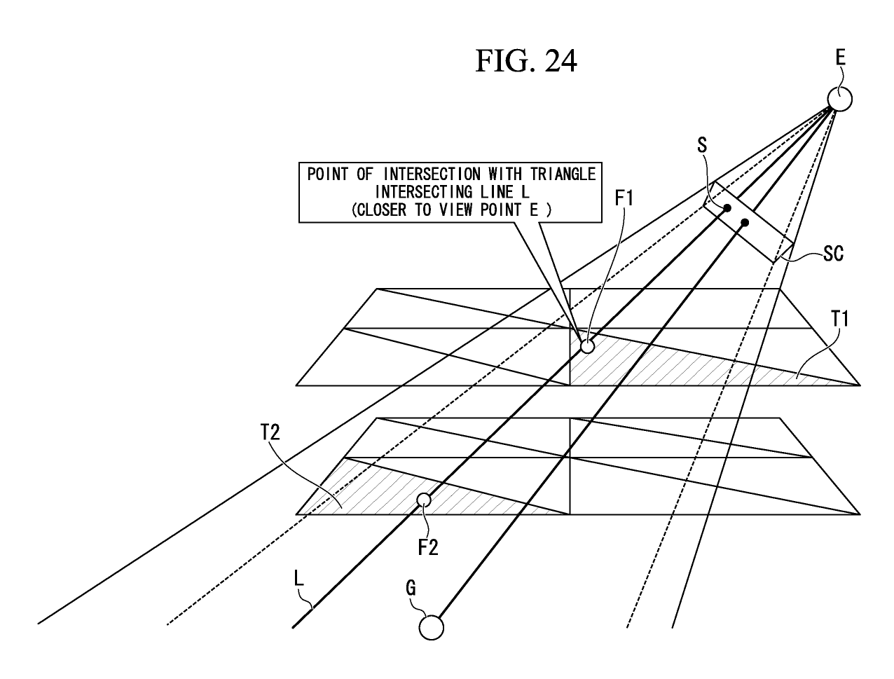

As illustrated in FIG. 24, the CPU 34c calculates intersection points between the line L and the triangles T1 and T2 and designates the calculated intersection points as intersection points F1 and F2. Here, because three-dimensional coordinates are desired to be calculated in the 3D object surface, the CPU 34c selects the intersection point closer to the view point E between the intersection points F1 and F2. In this case, the CPU 34c calculates three-dimensional coordinates of the intersection point F1 as three-dimensional coordinates in the 3D object surface. Although the number of triangles determined to intersect the line L is only 2 as described above, more triangles may be determined to intersect according to a shape of the 3D object or a line-of-sight direction. In this case, intersection points between the line L and the triangles are obtained, and an intersection point closest to the view point E is selected from among the obtained intersection points.

As described above, three-dimensional coordinates of a reference point (3D) can be calculated. Three-dimensional coordinates of a reference point designated in a measurement process to be described later can also be calculated as described above.

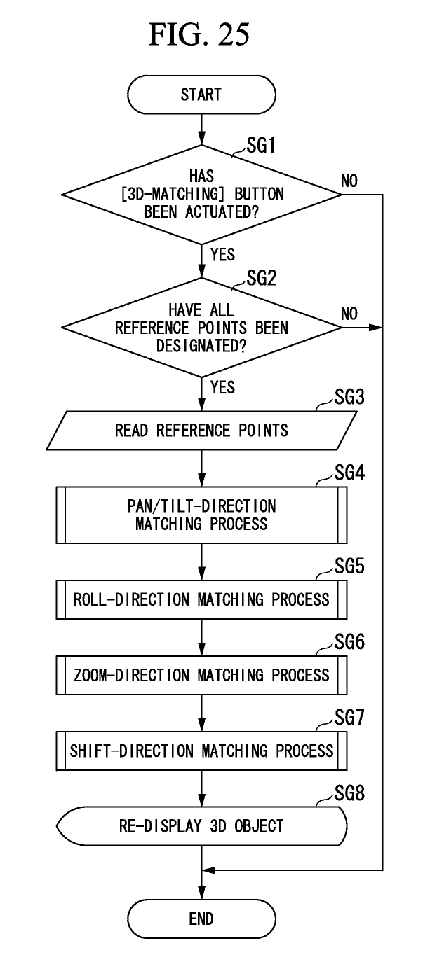

Next, a flow of the 3D matching process of step SG will be described using FIG. 25. In step SG1, the CPU 34c checks whether or not the user has actuated the “3D-Matching” button 664. If the “3D-Matching” button 664 has been actuated, the process moves to step SG2. If the “3D-Matching” button 664 has not been actuated, the 3D matching process ends.

In step SG2, the CPU 34c checks whether or not all reference points have been designated. Specifically, the CPU 34c checks whether or not reference points (measurement) and reference points (3D) have already been designated three by three. If all the reference points have been designated, the process moves to step SG3. The 3D matching process ends if the reference points have not been designated. In step SG3, the CPU 34c reads coordinates of all the reference points recorded on the RAM 34a.

In step SG4, the CPU 34c performs a matching process of the pan/tilt direction based on the coordinates of the designated reference points. Details of the matching process of the pan/tilt direction will be described later. In step SG5, the CPU 34c performs the matching process of the roll direction based on the coordinates of the designated reference points. Details of the matching process of the roll direction will be described later.

In step SG6, the CPU 34c performs a matching process of the zoom direction based on the coordinates of the designated reference points. Details of the matching process of the zoom direction will be described later. In step SG7, the CPU 34c performs the matching process of the shift direction based on the coordinates of the designated reference points. Details of the matching process of the shift direction will be described later.

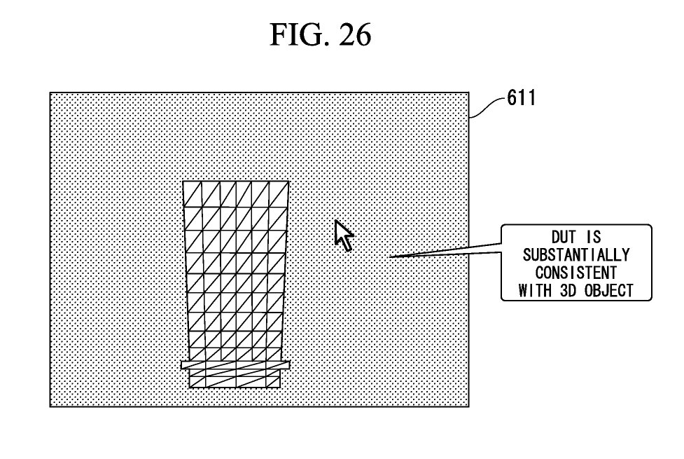

In step SG8, the CPU 34c performs a process of re-displaying the 3D object in the “Measurement Image” box 611. At this time, the pose and position of the 3D object are adjusted and displayed based on the camera pose and the shift position finally calculated in steps SG4 to SG7. FIG. 26 illustrates the DUT and the 3D object imaged in a measurement image after the matching process. As illustrated in FIG. 26, it can be seen that the DUT imaged in the measurement image is substantially consistent with the 3D object, that is, that the two suitably match. If the process of step SG8 ends, the 3D matching process ends. It is possible to adjust the pose of a virtual camera imaging the 3D object so that the pose is close to that of a camera (the endoscope apparatus 3) imaging the DUT by performing the above-described 3D matching process. That is, it is possible to adjust the pose of the 3D object so that the pose is close to that of the DUT in the measurement image and match the DUT and the 3D object.

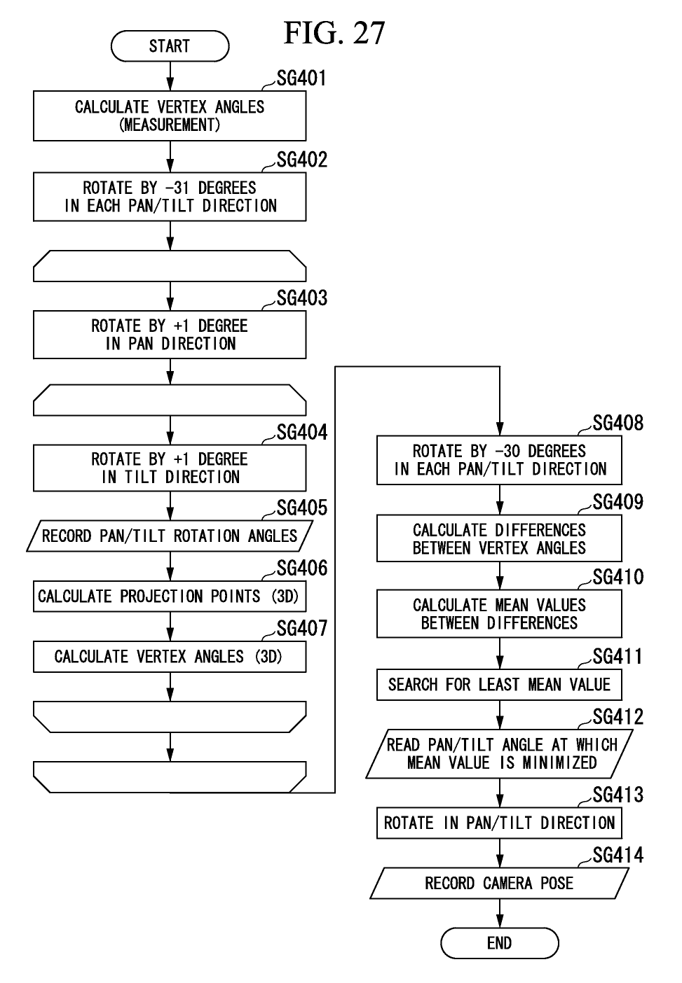

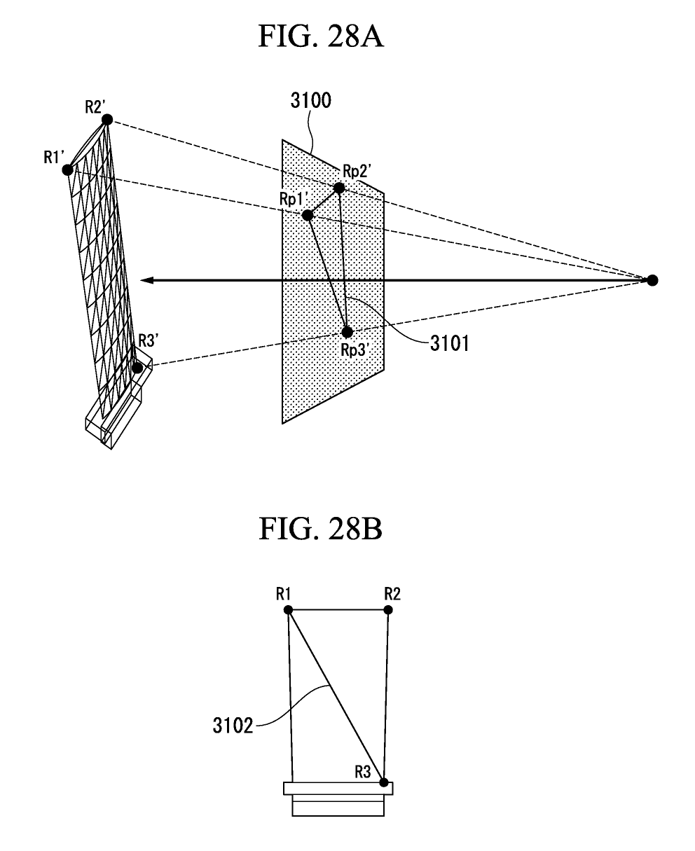

Next, a flow of the matching process of the pan/tilt direction of step SG4 will be described using FIG. 27. A purpose of the matching process of the pan/tilt direction is to find a camera pose in which a triangle constituted by reference points (measurement) is closest in similarity to a triangle constituted by projection points formed by reference points (3D) descended on the screen plane. If the triangles are close in similarity to each other, the pan/tilt direction of the line of sight when the DUT imaged in the measurement image is imaged can be substantially consistent with the pan/tilt direction of the line of sight in which the 3D object is observed. Hereinafter, as illustrated in FIG. 28A, projection points Rp1′ to Rp3′ formed by descending the reference points (3D) R1′ to R3′ on the screen plane 3100 are referred to as projection points (3D). Further, a triangle 3102 constituted by the reference points (measurement) R1 to R3 as illustrated in FIG. 28B is referred to as a reference graphic (measurement), and a triangle 3101 constituted by the projection points (3D) Rp1′ to Rp3′ as illustrated in FIG. 28A is referred to as a reference graphic (3D).

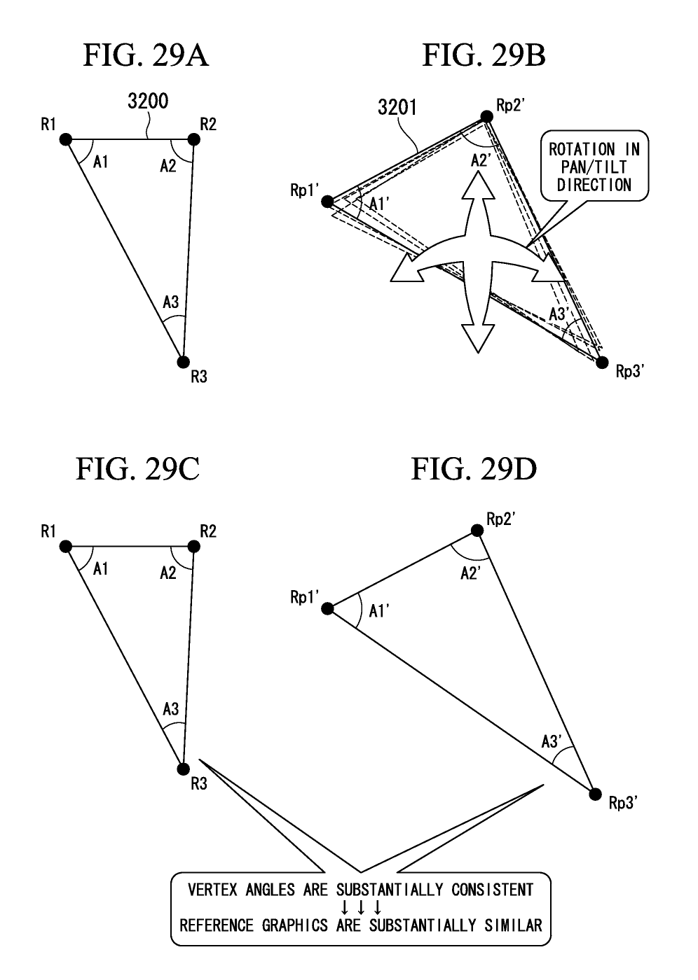

In step SG401, the CPU 34c calculates vertex angles (measurement), and records the calculated vertex angles (measurement) on the RAM 34a. As illustrated in FIG. 29A, the vertex angles (measurement) are angles A1 to A3 of three vertex points R1 to R3 of the reference graphic (measurement).

In step SG402, the CPU 34c rotates the camera pose by −31 degrees in the pan/tilt direction. Although an iterative process is performed in steps SG403 to SG407, this is to sequentially calculate the vertex angles (3D) while the camera pose rotates in the pan/tilt direction as illustrated in FIG. 29B. As illustrated in FIG. 29B, vertex angles (3D) are angles A1′ to A3′ of the three projection points (3D) Rp1′ to Rp3′ of a reference graphic (3D) 3201.

As described above, reference points (measurement) are associated with reference points (3D) in the order in which the reference points have been designated, and the angles A1 to A3 are also associated with the angles A1′ to A3′ in this order. In FIGS. 29A to 29D, the angle A1 is associated with the angle A1′, the angle A2 is associated with the angle A2′, and the angle A3 is associated with the angle A3′.

In step SG403, the CPU 34c rotates the camera pose by +1 degree in the pan direction. In steps SG403 to SG407, the CPU 34c performs an iterative process until the rotation angle of the pan direction of the camera pose reaches +30 degrees. The CPU 34c rotates the camera pose by +1 degree per iteration from −30 degrees to +30 degrees in the pan direction. As a result, a series of processes of steps SG403 to SG407 is iterated 61 times.

In step SG404, the CPU 34c rotates the camera pose by +1 degree in the tilt direction. In steps SG404 to SG407, the CPU 34c performs an iterative process until the rotation angle of the tilt direction of the camera pose reaches +30 degrees. The CPU 34c rotates the camera pose by +1 degree per iteration from −30 degrees to +30 degrees in the tilt direction. As a result, the process of steps SG404 to SG407 is iterated 61 times. Although the camera pose rotates from −30 degrees to +30 degrees in the iterative process of steps SG403 to SG407, the range in which the camera pose rotates is not necessarily limited thereto.

According to a degree of matching between the DUT and the 3D object imaged in the measurement image when the user changes the camera pose in the camera-pose setting process of step SD, a range necessary to rotate the camera pose in the iterative process of steps SG403 to SG407 varies. If the range is wide, it is preferable that the user perform rough matching, but a processing time of 3D matching becomes long instead. If the range is narrow, the processing time of 3D matching is shortened, but it is necessary to perform matching in detail to a certain extent.

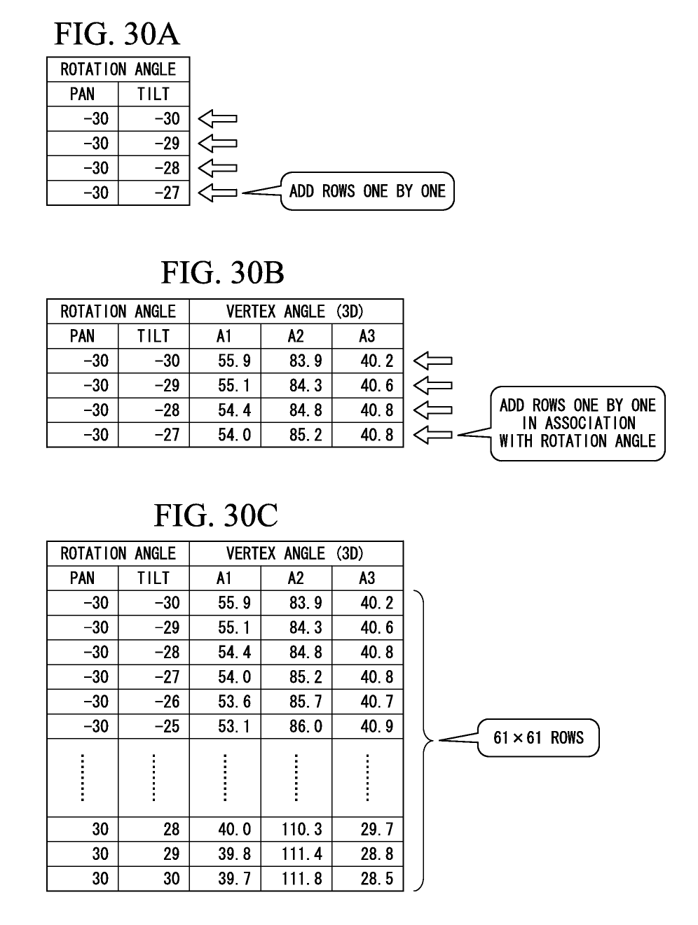

In step SG405 the CPU 34c records the rotation angle of a current pan/tilt direction on the RAM 34a. FIGS. 30A to 30C illustrate rotation angles recorded on the RAM 34a. In step SG405, the CPU 34c additionally records the rotation angle of the current pan/tilt direction on the data list provided in the RAM 34a row by row as illustrated in FIG. 30A every time the camera pose rotates in the pan/tilt direction, without overwriting the rotation angle on the RAM 34a. It is possible to record various data such as vertex angles (3D) in association with rotation angles of the pan/tilt direction as will be described later.

In step SG406, the CPU 34c calculates the projection points (3D), and records the calculated projection points (3D) on the RAM 34a. In step SG407, the CPU 34c calculates the vertex angles (3D), and records the calculated vertex angles (3D) on the RAM 34a. At this time, as illustrated in FIG. 30B, the CPU 34c records the vertex angles (3D) in a data list row by row in association with the rotation angles of the pan/tilt direction.

If the iterative process of steps SG403 to SG407 ends, the process moves to step SG408. At this time, the data list includes data of 61×61 rows as illustrated in FIG. 30C. In step SG408, the CPU 34C rotates the camera pose by −30 degrees in the pan/tilt direction. Here, the camera pose returns to the original state by rotation of −30 degrees because each rotation angle of the pan/tilt direction is +30 degrees when the iterative process of steps SG403 to SG407 has ended.

In step SG409, the CPU 34c calculates differences between vertex angles (measurement) and vertex angles (3D). Specifically, as shown in Expressions (1) to (3), the CPU 34c calculates absolute values D1 to D3 of differences between vertex angles (measurement) A1 to A3 and vertex angles (3D) A1′ to A3′.

D1=|A1−A1′| (1)

D2=|A2−A2′| (2)

D3=|A3−A3′| (3)

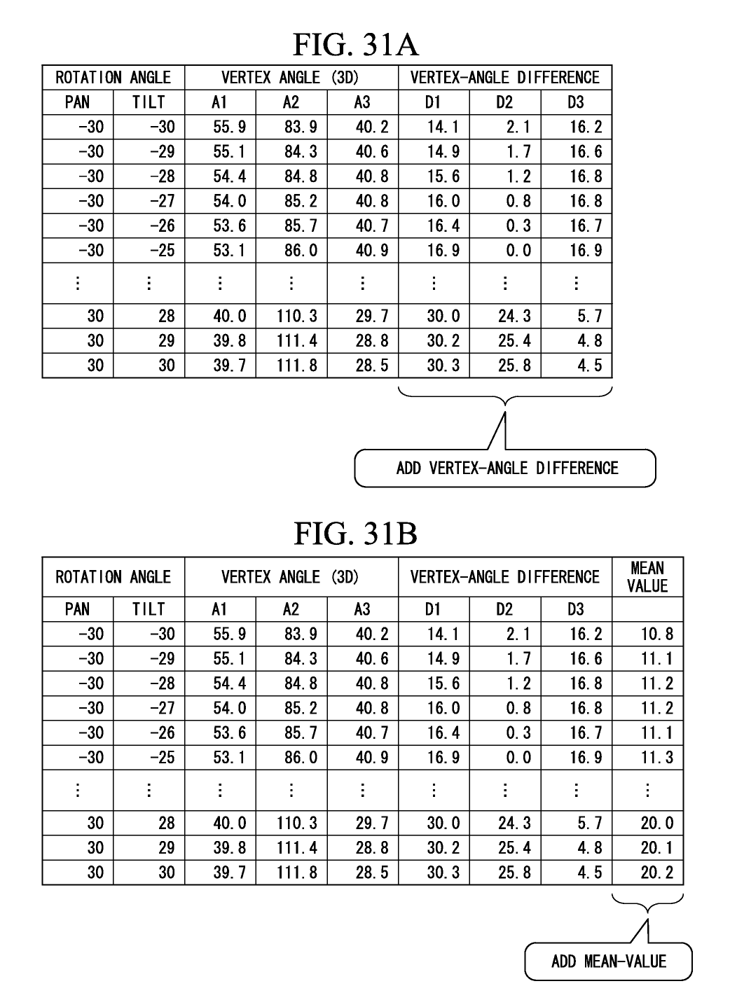

Further, the CPU 34c additionally records vertex-angle differences in the data list in association with the rotation angles of the pan/tilt direction as illustrated in FIG. 31A.

In step SG410, the CPU 34c calculates mean values between the differences D1 to D3. Further, the CPU 34c additionally records the mean values to the data list in association with the rotation angles of the pan/tilt direction as illustrated in FIG. 31B.

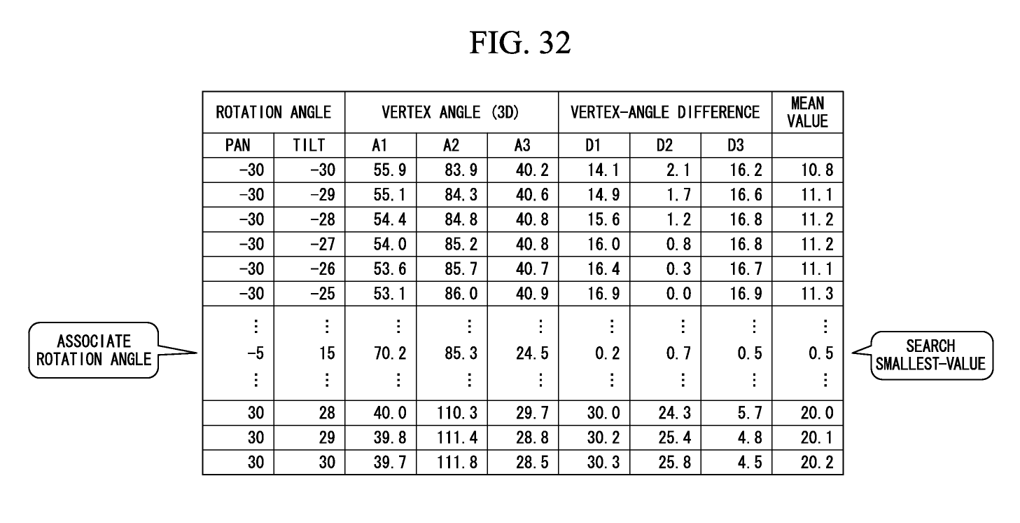

In step SG411, the CPU 34c searches for the smallest value among the mean values from the data list. FIG. 32 illustrates a state in which 0.5 is searched as the smallest value in the data list.

In step SG412, the CPU 34c reads the rotation angle of the pan/tilt direction when the mean value is the smallest from the data list. Specifically, the CPU 34c reads the rotation angle of the pan/tilt direction associated with the least mean value from the data list as illustrated in FIG. 32.

In step SG413, the CPU 34c rotates the camera pose by the rotation angle read in step SG412 in the pan/tilt direction. If the 3D object is displayed in the camera pose, it can be seen that the vertex angles (measurement) after rotation are quite consistent with the vertex angles (3D) and the reference graphic (measurement) is close in similarity to the reference graphic (3D) as illustrated in FIGS. 29C and 29D.

In step SG414, the CPU 34c overwrites and records the camera pose of this time on the RAM 34a as the current camera pose. Here, the 3D object based on the current camera pose is not re-displayed. If the process of step SG414 ends, the matching process of the pan/tilt direction ends.

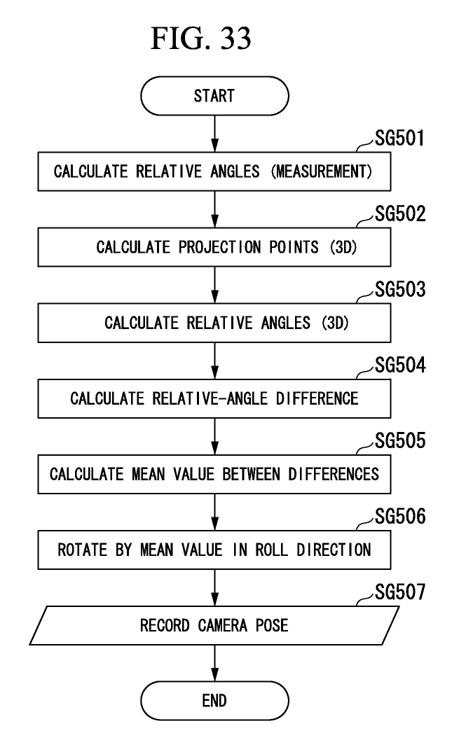

Next, a flow of the matching process of the roll direction of step SG5 will be described using FIG. 33. A purpose of the matching process of the roll direction is to find a camera pose in which angles of the rotation direction of the reference graphic (measurement) and the reference graphic (3D) are most consistent. If the angles of the rotation direction of the reference graphics are close to each other, the rotation angle of the roll direction of the line of sight in which the DUT imaged in the measurement image is observed can be substantially consistent with the rotation angle of the roll direction of the line of sight in which the 3D object is observed.

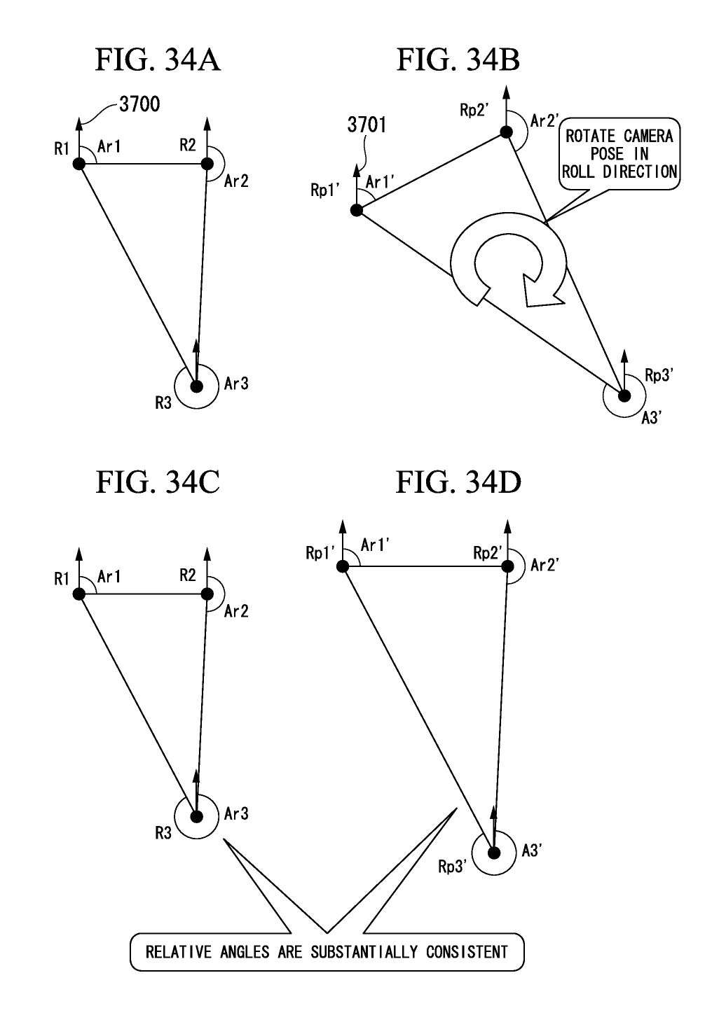

In step SG501, the CPU 34c calculates relative angles (measurement), and records the calculated relative angles (measurement) on the RAM 34a. As illustrated in FIG. 34A, the relative angles (measurement) are angles Ar1 to Ar3 between a straight line 3700 vertically extending in the measurement image and three sides of the reference graphic (measurement). At this time, the relative angle (measurement) is an angle of a clockwise direction from the line 3700 to the side.

In step SG502, the CPU 34c calculates projection points (3D), and records the calculated projection points (3D) on the RAM 34a. In step SG503, the CPU 34c calculates relative angles (3D), and records the calculated relative angles (3D) on the RAM 34a. As illustrated in FIG. 34B, the relative angles (3D) are angles Ar1′ to Ar3′ between a line 3701 vertically extending on the screen plane and three sides of the reference graphic (3D). Because the screen plane corresponds to the “Measurement Image” box 611 on which the measurement image is displayed, the direction of the 3700 is consistent with that of the line 3701. In addition, at this time, the relative angle (3D) is an angle of the clockwise direction from the line 3701 to the side.

In step SG504, the CPU 34c calculates differences between vertex angles (measurement) and vertex angles (3D). Specifically, as shown in Expressions (4) to (6), the CPU 34c calculates differences Dr1 to Dr3 between the relative angles (measurement) Ar1 to Ar3 and the relative angles (3D) Ar1′ to Ar3′.

Dr1=Ar1−Ar1′ (4)

Dr2=Ar2−Ar2′ (5)

Dr3=Ar3−Ar3′ (6)

In step SG505, the CPU 34c calculates mean values between the differences Dr1 to Dr3, and records the calculated mean values on the RAM 34a. In step SG506, the CPU 34c rotates the camera pose by the mean value calculated in step SG505 in the roll direction. It can be seen that the relative angle (measurement) after rotation is quite consistent with the relative angle (3D) as illustrated in FIGS. 34C and 34D if the 3D object is displayed in the camera pose.

In step SG507, the CPU 34c overwrites and records the camera pose of this time on the RAM 34a as the current camera pose. Here, the 3D object based on the current camera pose is not re-displayed. If the process of step SG507 ends, the matching process of the roll direction ends.

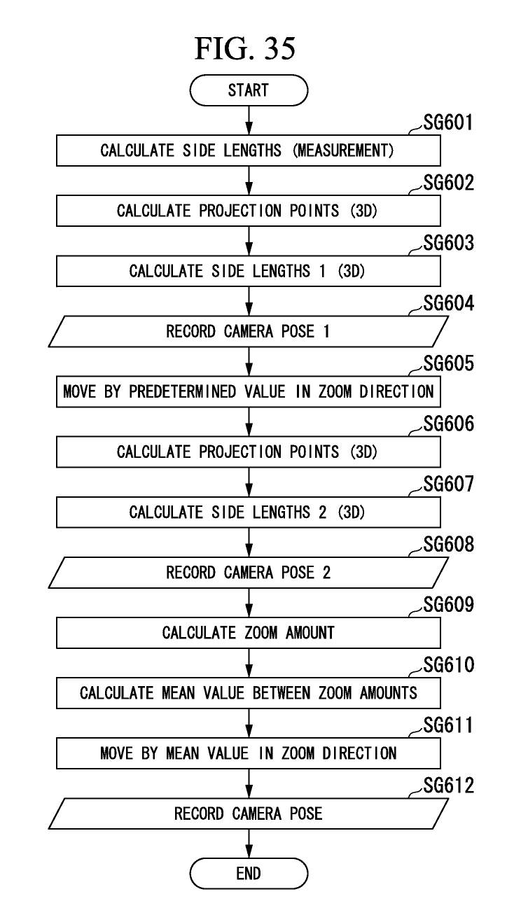

Next, a flow of the matching process of the zoom direction of step SG6 will be described using FIG. 35. A purpose of the matching process of the zoom direction is to find a camera pose in which sizes of the zoom direction of the reference graphic (measurement) and the reference graphic (3D) are most consistent. If the sizes of the reference graphics are close to each other, the position of the zoom direction of the line of sight in which the DUT imaged in the measurement image is observed can be substantially consistent with the position of the zoom direction of the line of sight in which the 3D object is observed.

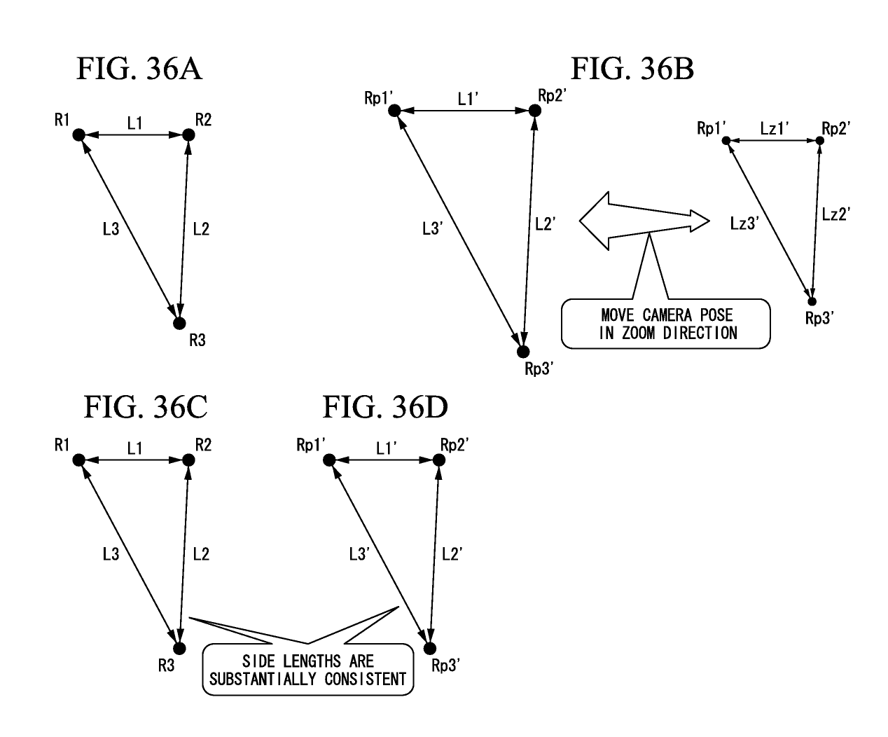

In step SG601, the CPU 34c calculates side lengths (measurement) and records the calculated side lengths on the RAM 34a. As illustrated in FIG. 36A, the side lengths (measurement) are three side lengths of a triangle constituted by reference points (measurement) R1 to R3.

In step SG602, the CPU 34c calculates projection points (3D) and records the calculated projection points (3D) on the RAM 34a. In step SG603, the CPU 34c calculates side lengths 1 (3D) and records the calculated side lengths 1 on the RAM 34a. The side lengths 1 (3D) are three side lengths L1′ to L3′ of the reference graphic (3D) as illustrated in FIG. 36B.

In step SG604, the CPU 34c overwrites and records the camera pose of this time on the RAM 34a as a camera pose 1. In step SG605, the CPU 34c moves the camera pose by a predetermined value in the zoom direction as illustrated in FIG. 36B.

In step SG606, the CPU 34c calculates projection points (3D) and records the calculated projection points (3D) on the RAM 34a. In step SG607, the CPU 34c calculates side lengths 2 (3D) and records the side lengths 2 (3D) on the RAM 34a. The side lengths 2 (3D) are three side lengths Lz1′ to Lz3′ of the reference graphic (3D) after the camera pose is moved by the predetermined value in the zoom direction as illustrated in FIG. 36B. In step SG608, the CPU 34c overwrites and records the camera pose of this time on the RAM 34a as a camera pose 2.

In step SG609, the CPU 34c calculates zoom amounts and records the calculated zoom amounts. The zoom amount is a moving amount of the zoom direction of the camera pose in which the side length (3D) is consistent with the side length (measurement) and is calculated from relationships between side lengths 1 and 2 (3D) and camera poses 1 and 2. Because there are three sides, three zoom amounts are calculated.

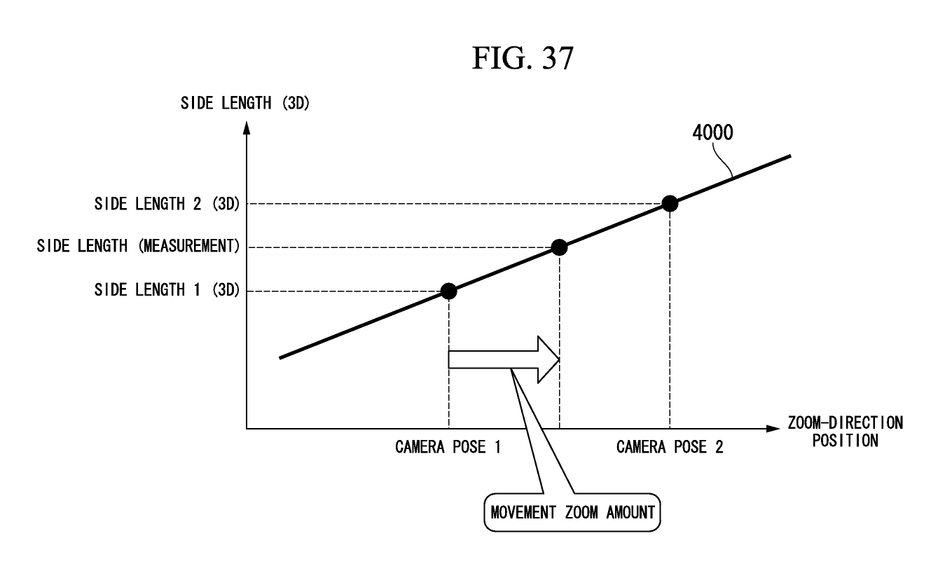

FIG. 37 illustrates the relationship between the side length (3D) and the zoom-direction position of the camera pose. As illustrated in a graph 4000 of FIG. 37, the two are in a linear proportional relationship. It is possible to calculate the moving amount when the camera pose moves in the zoom direction if the side length (3D) is consistent with the side length (measurement) using the graph 4000.

In step SG610, the CPU 34c calculates a mean value between three zoom amounts and records the calculated mean value on the RAM 34a. In step SG611, the CPU 34c moves the camera pose by the mean value calculated in step SG611 in the zoom direction. When the 3D object is displayed in the camera pose, it can be seen that a side length (measurement) after movement is quite consistent with a side length (3D) as illustrated in FIGS. 36C and 36D.

In step SG612, the CPU 34c overwrites and records the camera pose of this time on the RAM 34a as the camera pose. Here, the 3D object based on the current camera pose is not re-displayed. If the process of step SG612 ends, the matching process of the zoom direction ends.

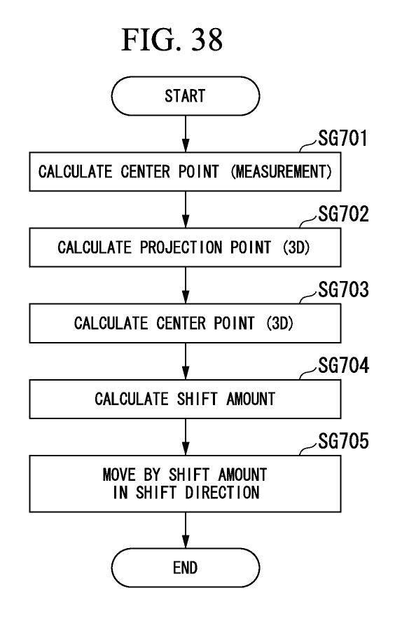

Next, a flow of the matching process of the shift direction of step SG7 will be described using FIG. 38. A purpose of the matching process of the shift direction is to move the 3D object in the shift direction so that the DUT and the 3D object imaged in the measurement image are consistent in the “Measurement Image” box 611. Because this process determines the shift position of the 3D object, the camera pose is not calculated.

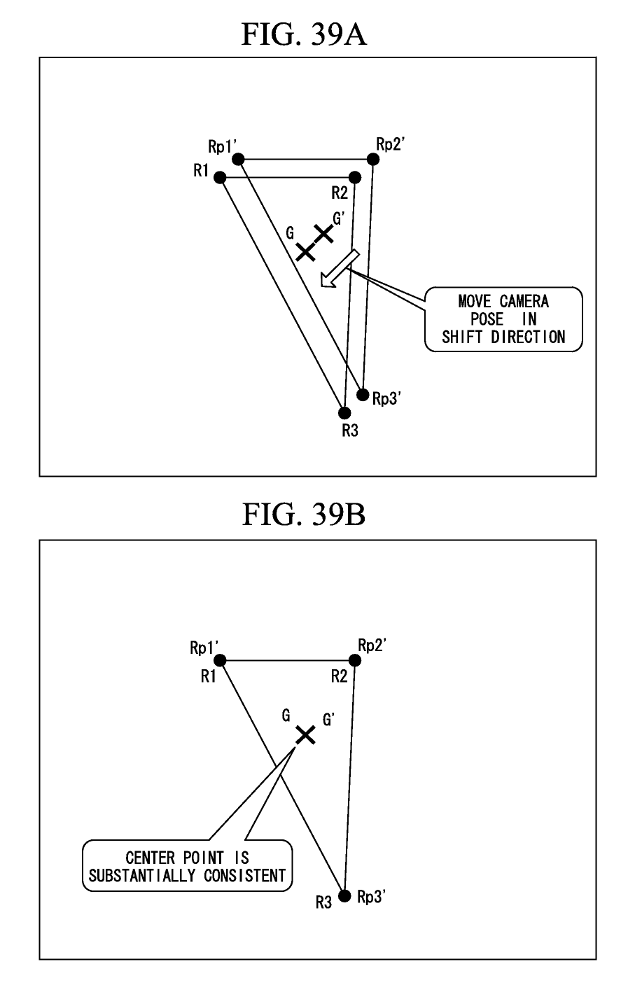

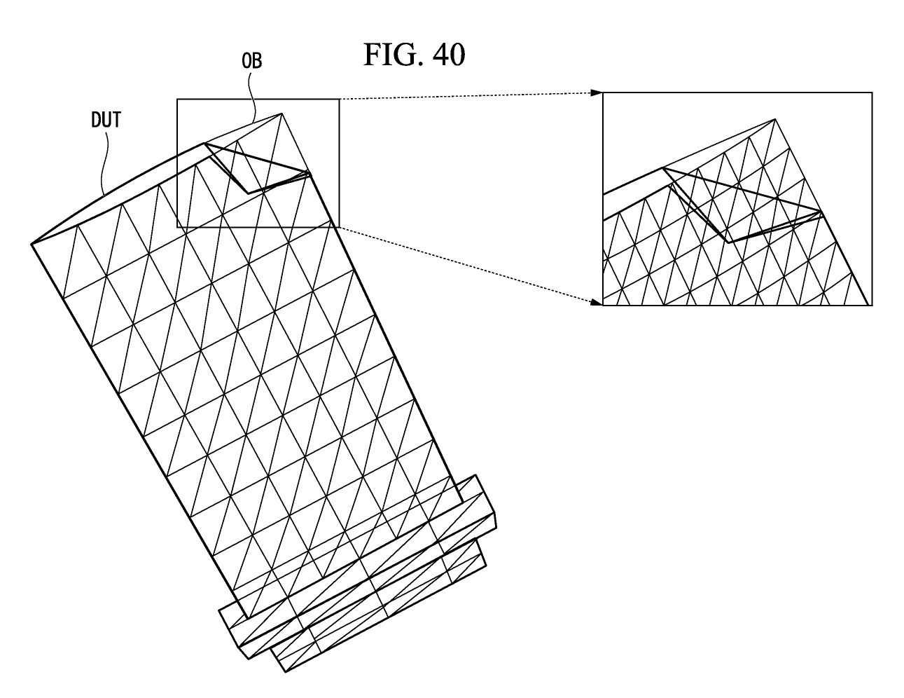

In step SG701, the CPU 34c calculates a center point (measurement) and records the calculated center point (measurement) on the RAM 34a. As illustrated in FIG. 39A, the center point (measurement) is a center point G of a triangle constituted by reference points (measurement) R1 to R3.

In step SG702, the CPU 34c calculates projection points (3D) and records the calculated projection points (3D) on the RAM 34a. In step SG703, the CPU 34c calculates a center point (3D) and records the calculated center point (3D) on the RAM 34a. As illustrated in FIG. 39A, the center point (3D) is a center point G′ of a triangle constituted by projection points (measurement) Rp1′ to Rp3′.

In step SG704, the CPU 34c calculates a shift amount and records the calculated shift amount on the RAM 34a. The shift amount is a relative position between the center point (measurement) and the center point (3D) (in units of pixels in the plane coordinate system). In step SG705, the CPU 34c moves the 3D object by the shift amount calculated in step SG704 in the shift direction. If the 3D object is displayed in the camera pose, it can be seen that the center point (measurement) is quite consistent with the center point (3D) as illustrated in FIG. 39B. If the process of step SG705 ends, the matching process of the shift direction ends.

When the 3D matching process is executed in the first preferred embodiment, it is preferable that only a simple geometric calculation based on a reference graphic having a plain shape designated by the user be executed, and it is possible to significantly shorten the processing time. Further, it is preferable to re-display the 3D object only once after the 3D matching process ends.

Next, a measurement process of the first preferred embodiment will be described. First, a bend (curvature) measurement flow will be described. After the 3D matching process of step SG ends, the DUT and the 3D object OB as illustrated in FIG. 40 are displayed in the “Measurement Image” box 611. Here, the DUT imaged in the measurement image has a corner in a bent state. That is, the DUT is in a defective state of the bend (curvature). In the measurement process of step SH, the CPU 34c designates (sets) a reference point based on an instruction for designating a position on the 3D object of the “Measurement Image” box 611, modifies the 3D object based on the designated reference point, and performs measurement based on the reference point. Thereby, the user can check a shape and a size of a defect occurring in the DUT.

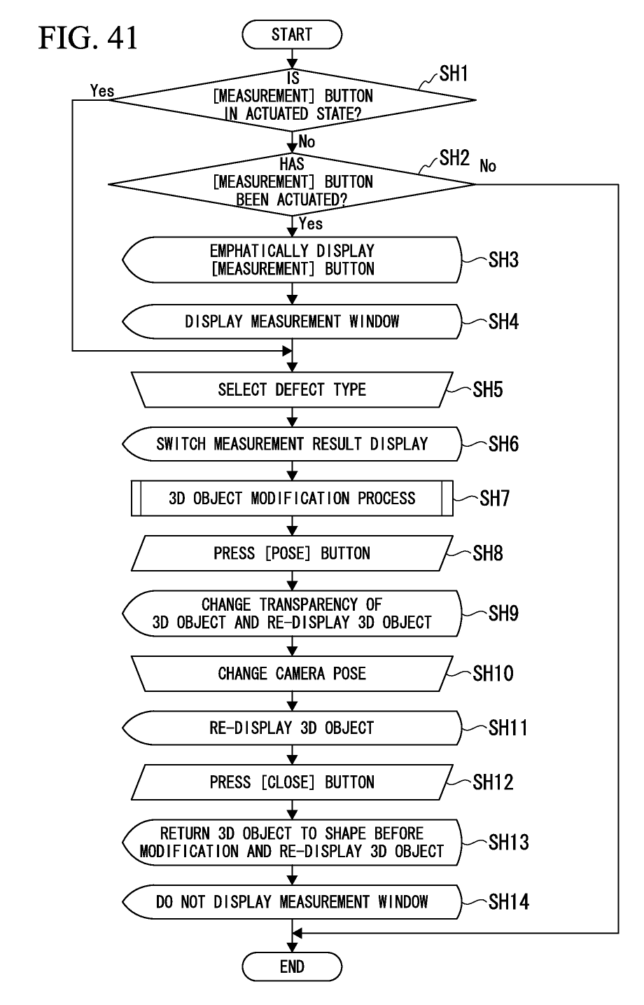

A flow of the measurement process of step SH will be described using FIG. 41. In step SH1, the CPU 34c checks whether or not the “Measurement” button 665a has already been actuated (step SH3 has already been performed). If the “Measurement” button 665a is in the actuated state, the process moves to step SH5. If the “Measurement” button 665a is not in the actuated state, the process moves to step SH2.

In step SH2, the CPU 34c checks whether or not the user has actuated the “Measurement” button 665a. If the “Measurement” button 665a has been actuated, the process moves to step SH3. If the “Measurement” button 665a has not been actuated, the measurement process ends.

In step SH3, the CPU 34c performs a process of emphatically displaying the “Measurement” button 665a. The process of emphatically displaying the “Measurement” button 665a is used to notify the user that the reference point can be currently designated for the 3D object.

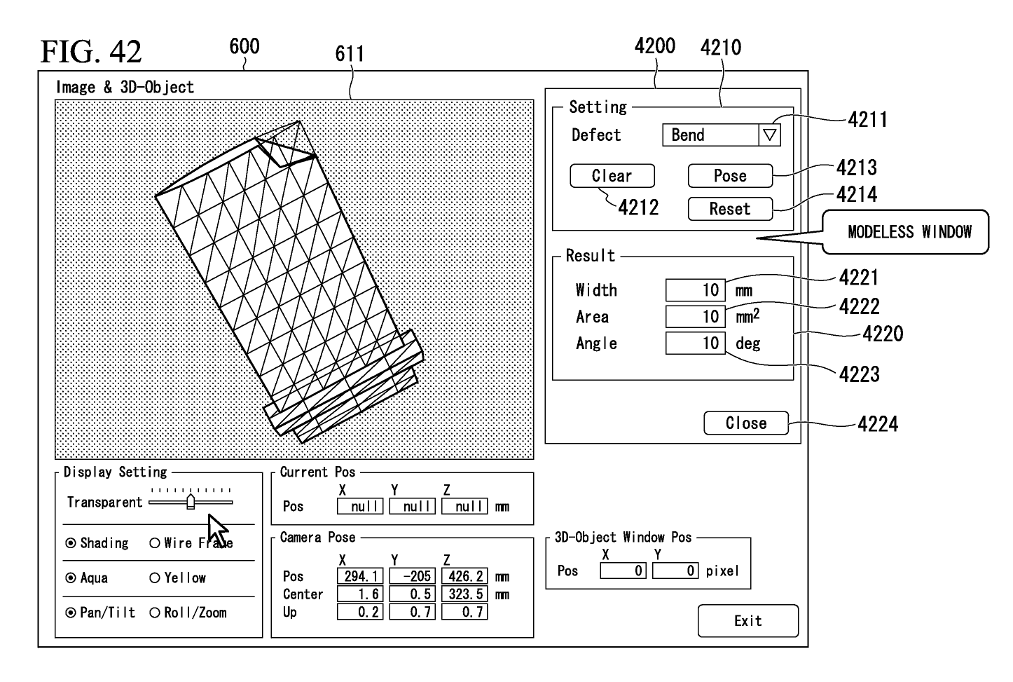

In step SH4, the CPU 34c displays a measurement window 4200 on a main window 600 as illustrated in FIG. 42. At this time, the displayed measurement window 4200 is a modeless window, and the user can operate both the main window 600 and the measurement window 4200. Further, the measurement window 4200 is constantly superimposed and displayed on the top (front side) in the main window 600.

Here, functions of various GUIs arranged on the measurement window 4200 will be described using FIG. 42. In the upper portion of the measurement window 4200, a “Setting” box 4210 is arranged. In the lower portion of the measurement window 4200, a “Result” box 4220 is arranged. Inside the “Setting” box 4210, GUIs related to settings of a measurement process are arranged. Inside the “Result” box 4220, GUIs related to measurement results are arranged.

Inside the “Setting” box 4210, a “Defect” combo box 4211, a “Clear” box 4212, a “Pose” button 4213, and a “Reset” button 4214 are arranged. The “Defect” combo box 4211 is a box for selecting the type of defect measured by the user. It is possible to select three types of “bend,” “crack,” and “dent.” The “Pose” button 4213 is a button for moving the camera pose of the 3D object OB after modification displayed in the “Measurement Image” box 611 to a changeable state.

The “Clear” button 4212 is a button for clearing the reference point already designated for the 3D object in the “Measurement Image” box 611. The “Reset” button 4214 is a button for returning the camera pose changed after the press of the “Pose” button 4213 to the original camera pose before the press of the “Pose” button 4213 in “Measurement Image” box 611. Details of a process to be performed by the CPU 34c when the “Clear” button 4212 and the “Reset” button 4214 have been pressed will not be described.

Inside the “Result” box 4220, text boxes 4221, 4222, and 4223, which indicate “Width,” “Area,” and “Angle,” as defect measurement results, respectively, are arranged. FIG. 42 illustrates a state of the measurement window 4200 when “bend” is selected in the “Defect” combo box 4211. When another defect is selected in the “Defect” combo box 4211, measurement results corresponding to the defect are displayed.

In a lower portion of the measurement window 4200, a “Close” button 4224 is arranged. The “Close” button 4224 is a button for ending the measurement process. If the “Close” button 4224 is pressed, the measurement window 4200 is not displayed.

The process of steps SH5 and SH6 is a process for selecting the type of defect occurring in the DUT in the measurement image. In step SH5, the CPU 34c selects the type of defect based on information designated by the user in the “Defect” combo box 4211. If the DUT imaged in the measurement image has the bend as a defect, the user selects “bend” in the [Defect] combo box 4211.

In step SH6, the CPU 34c switches a display of the “Result” box 4220 according to the type of defect selected in step SH5. If “bend” is selected as the type of defect, the text boxes 4221, 4222, and 4223, which indicate “Width,” “Area,” and “Angle” of the defect, respectively, are displayed in the “Result” box 4220 as illustrated in FIG. 42.

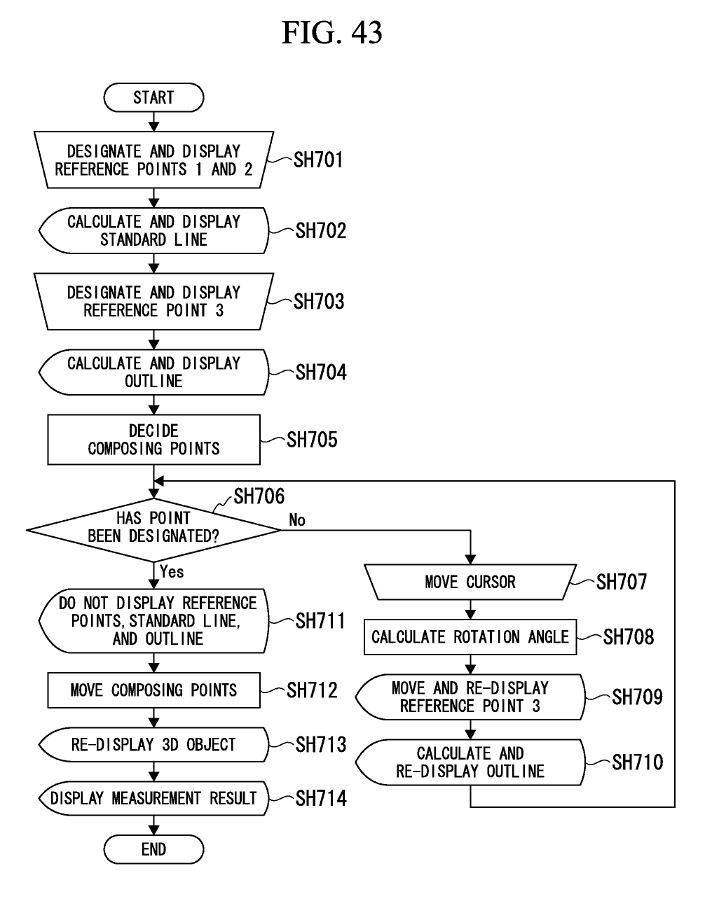

In step SH7, the CPU 34c performs a 3D object modification process. The 3D object modification process is a process of modifying the 3D object based on the reference point designated by the user. Here, a flow of the 3D object modification process separate from the flow of the measurement process of FIG. 41 will be described using FIG. 43.

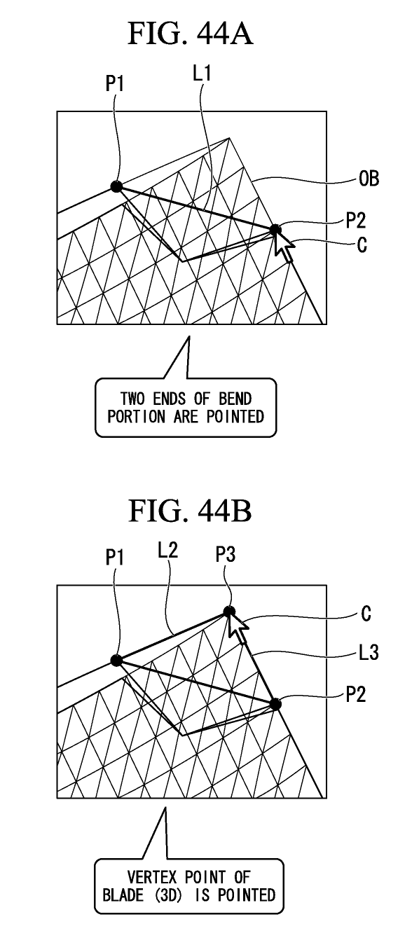

FIG. 43 illustrates the flow of the 3D object modification process when the “bend” is selected in the “Defect” combo box 4211. If the user designates reference points 1 and 2 (P1 and P2) for the 3D object OB by means of the cursor C in the “Measurement Image” box 611 in step SH701 as illustrated in FIG. 44A, the CPU 34c performs a process of calculating three-dimensional coordinates of the designated reference points 1 and 2 (P1 and P2) based on the plane coordinates in the position of the cursor C and displaying the reference points 1 and 2 on the 3D object OB as black circle marks. The reference points 1 and 2 become standard points (first standard points) when the 3D object OB is modified. The user designates three-dimensional points on the 3D object OB positioned at two ends of a bend portion in the DUT as the reference points 1 and 2.

In step SH702, the CPU 34c calculates a three-dimensional line connecting the designated reference points 1 and 2 in a standard line. Further, in step SH702, the CPU 34c performs a process of displaying the standard line L1 as the straight line in the “Measurement Image” box 611 as illustrated in FIG. 44A.

In step SH703, if the user designates a reference point 3 (P3) for the 3D object OB by means of the cursor C in the “Measurement Image” box 611 as illustrated in FIG. 44B, the CPU 34c performs a process of calculating three-dimensional coordinates of the designated reference point 3 based on the plane coordinates in the position of the cursor C and displaying the reference point 3 on the 3D object OB as a black circle mark. The reference point 3 becomes a standard point (second standard point) when the 3D object OB is modified. The user designates a vertex point of the 3D object OB (a vertex point of a blade) as the reference point 3.

In step SH704, the CPU 34c calculates a three-dimensional line connecting the designated reference points 1 and 3 and a three-dimensional line connecting the reference points 2 and 3 in outlines. Further, in step SH704, the CPU 34c performs a process of displaying outlines L2 and L3 as straight lines in the “Measurement Image” box 611 as illustrated in FIG. 44B.

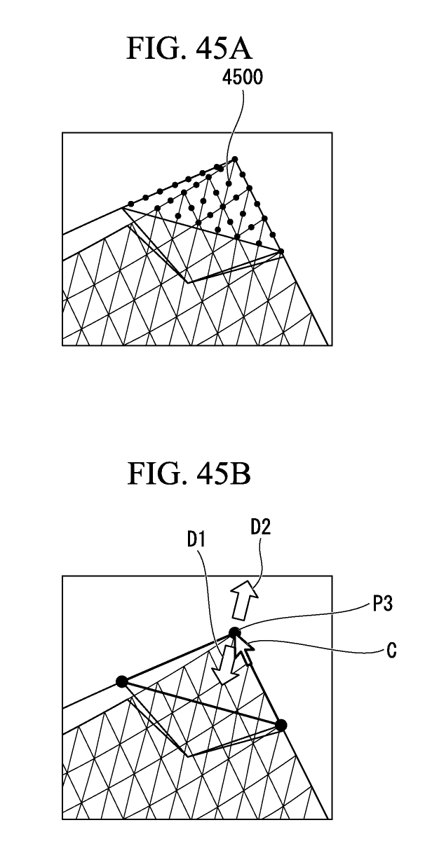

In step SH705, the CPU 34c decides composing points. The composing points are a gathering of three-dimensional points serving as targets of rotational movement as will be described later among three-dimensional points constituting the 3D object. Here, as illustrated in FIG. 45A, the decided composing points are three-dimensional points 4500 constituting the 3D object OB positioned inside a triangle surrounded by a standard line and an outline in the “Measurement Image” box 611.

In step SH706, the CPU 34c checks whether or not the user has designated the point in the “Measurement Image” box 611. Here, the CPU 34c checks whether or not the modification of the 3D object OB has been completed according to whether or not the point has been designated.

If the user moves the cursor C as will be described later, the reference point 3 rotationally moves according to movement of the cursor C. If a position of the rotationally moved reference point 3 is consistent with the position of a vertex point of the bend portion in the DUT of the measurement image, the user designates a point (third standard point). If the point has been designated, the process moves to step SH711. If no point has been designated, the process moves to step SH707.

In step SH707, the CPU 34c detects a movement instruction of the cursor C input by the user via the remote controller 23 in the “Measurement Image” box 611, and calculates the position and movement amount of the cursor C based on the movement instruction. In step SH708, the CPU 34c calculates a rotation angle according to the amount of movement of the cursor C.

Here, as illustrated in FIG. 45B, it is preferable that the moving amount of the cursor C be a value that increases in a positive (+) direction when the cursor C is close from the initial position of the reference point 3 to the standard line L1 (the cursor C moves in a direction D1), and decreases in a negative (−) direction when the cursor C is far from the standard line L1 (the cursor C moves in a direction D2). The rotation angle is defined as an angle value proportional to the amount of movement from the initial position of the cursor C. The user can determine how much to rotate the reference point 3 and the composing point according to a movement position of the cursor C.

In step SH709, the CPU 34c calculates three-dimensional coordinates of the reference point 3 after rotational movement by designating the standard line L1 as a rotation axis and rotationally moving the reference point 3 by the rotation angle calculated in step S708. Further, in step SH709, the CPU 34c re-displays the reference point 3 after the rotational movement in the “Measurement Image” box 611. Details of the rotational movement process will be described later.

In step SH710, the CPU 34c calculates two three-dimensional lines connecting the reference points 1 and 3 and the reference points 2 and 3 as outlines based on the three-dimensional coordinates of the reference point 3 rotationally moved in step SH709. Further, in step SH710, the CPU 34c re-displays the outlines in the “Measurement Image” box 611.

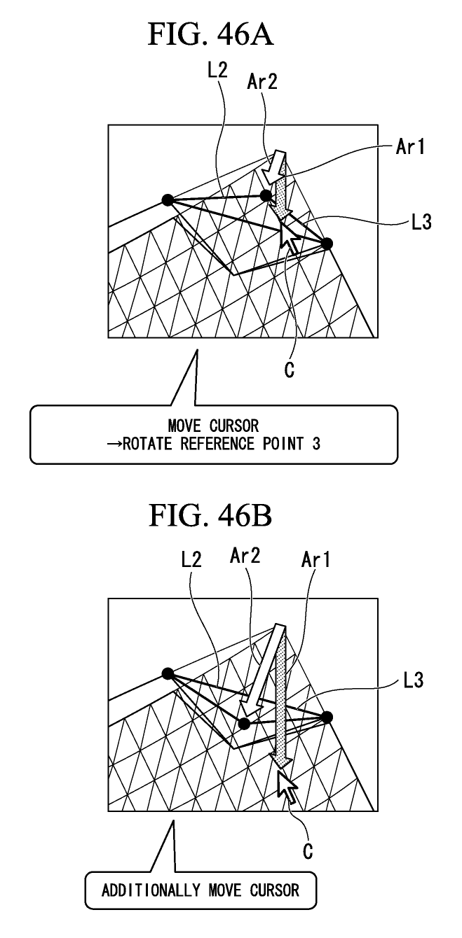

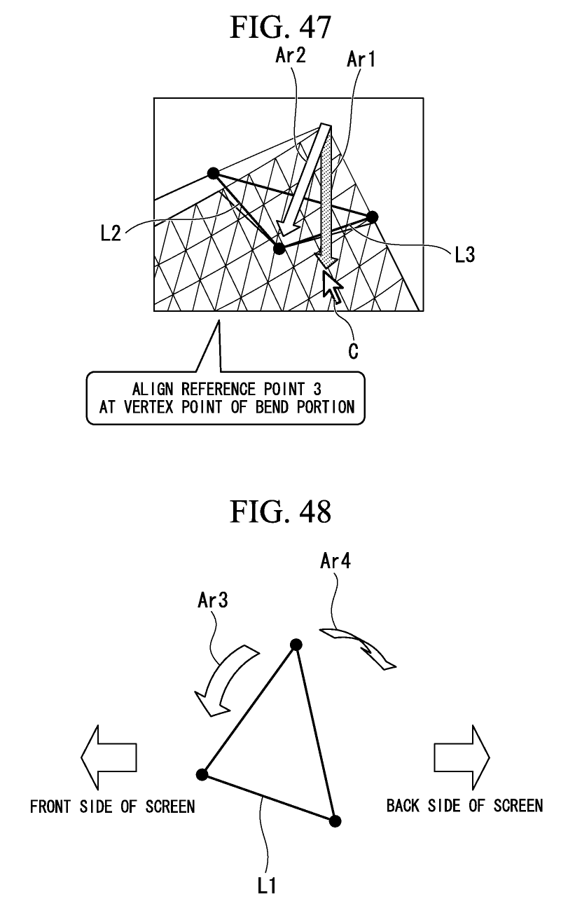

At this time, as illustrated in FIGS. 46A to 47, it can be seen that the reference point 3 rotationally moves as indicated by an arrow Ar2 in correspondence with movement of the cursor C as indicated by an arrow Ar1 and the reference point 3 after the rotational movement and the outlines L2 and L3 calculated based on the reference point 3 are re-displayed in the “Measurement Image” box 611.

FIG. 48 illustrates a state in which the reference points 1, 2, and 3, the standard line, and the outlines are viewed from the right side of the 3D object. The left side of FIG. 48 is the front side of the screen, and the right side is the back side of the screen. When the cursor C moves in a direction close to the standard line L 1, the reference point 3 rotationally moves to the front side of the screen as indicated by an arrow Ar3. When the cursor C moves in a direction far from the standard line L1, the reference point 3 rotationally moves to the back side of the screen as indicated by an arrow Ar4.

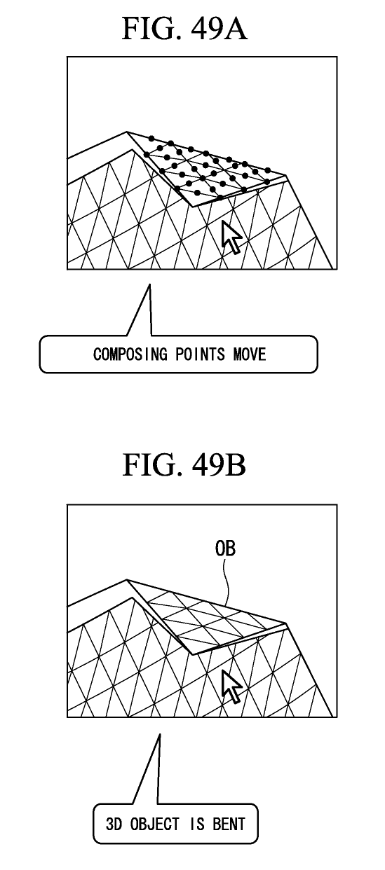

In step SH711, the CPU 34c does not display the reference points and the standard line already displayed in the “Measurement Image” box 611. In step SH712, the CPU 34c performs a process (rotational movement process) of rotationally moving the composing points using the standard line as a rotation axis. According to the rotational movement process, the composing points move as illustrated in FIG. 49A. Details of the rotational movement process will be described later.

In step SH713, the CPU 34c re-displays the 3D object OB in the “Measurement Image” box 611 based on the rotationally moved composing points as illustrated in FIG. 49B. At this time, it can be seen that the corner of the 3D object OB (the corner of the blade) is modified to be bent to the front side of the screen using the standard line as the axis. Although not illustrated, the corner of the 3D object can be modified to be bent to the back side of the screen by adjusting a movement position of the cursor C.

In step SH714, the CPU 34c calculates measurement results based on the reference points 1 and 2 and the reference point 3 after the rotational movement and displays the calculated measurement results in the “Result” box 4220. In the measurement of the bend, a width, an area, and an angle of the bend portion are calculated. The width of the bend portion is a length of the standard line L1 (a three-dimensional distance between the reference point 1 and the reference point 2). The area of the bend portion is an area of a three-dimensional triangle surrounded by the standard line L1 and the outlines L2 and L3. The angle of the bend portion is a rotation angle (angle of curvature) calculated in step SH708. The calculated width, area, and angle of the bend portion are displayed in the text boxes 4221, 4222, and 4223, respectively. If the process of step SH714 ends, the measurement process ends.

Next, details of the rotational movement process to be executed in step SH712 will be described. Hereinafter, a method of calculating coordinates after movement of a certain three-dimensional point S when the three-dimensional point S rotates using the standard line L1 as the rotation axis will be described.

When three-dimensional coordinates of the reference points 1 and 2 are (Pₓ₁, P_{y1}, P_{z1}) and (Pₓ₂, P_{y2}, P_{z2}), respectively, the standard line L1 is expressed by the following Expression (7).

$$\frac{x - {P}_{x 1}}{{P}_{x 2} - {P}_{x 1}} = \frac{y - {P}_{y 1}}{{P}_{y 2} - {P}_{y 1}} = \frac{z - {P}_{z 1}}{{P}_{z 2} - {P}_{z 1}} \qquad ( 7 )$$

If the three-dimensional length of the standard line L1 (the three-dimensional distance between the reference point 1 and the reference point 2) is L, the three-dimensional length is expressed by the following Expression (8).

L=\sqrt{(Pₓ₂−Pₓ₁)²+(P_{y2}−P_{y1})²+(P_{z2}−P_{z1})²} (8)

If a unit direction vector of the standard line L1 is n=(nₓ, n_{y}, n_{z}) in a direction extending from the reference point 1 to the reference point 2, the unit direction vector is expressed by the following Expression (9).

$$( {n}_{x} , {n}_{y} , {n}_{z} ) = ( \frac{{P}_{x 2} - {P}_{x 1}}{L} , \frac{{P}_{y 2} - {P}_{y 1}}{L} , \frac{{P}_{z 2} - {P}_{z 1}}{L} ) \qquad ( 9 )$$

When the three-dimensional point S rotates by designating the standard line L1 as the rotation axis, the relationship between coordinates of three-dimensional points S before and after the rotation are expressed by the following Expression (10) if the coordinates of the three-dimensional points S before and after the rotation are (x, y, z) and (x′, y′, z′), respectively.

$$( \begin{matrix}{x}^{′} \\ {y}^{′} \\ {z}^{′}\end{matrix} ) = ( \begin{matrix}{n}_{x}^{2} ( 1 - cos θ ) + cos θ & {n}_{x} {n}_{y} ( 1 - cos θ ) - {n}_{z} sin θ & {n}_{z} {n}_{x} ( 1 - cos θ ) + {n}_{y} sin θ \\ {n}_{x} {n}_{y} ( 1 - cos θ ) + {n}_{z} sin θ & {n}_{y}^{2} ( 1 - cos θ ) + cos θ & {n}_{y} {n}_{z} ( 1 - cos θ ) - {n}_{x} sin θ \\ {n}_{z} {n}_{x} ( 1 - cos θ ) - {n}_{y} sin θ & {n}_{y} {n}_{z} ( 1 - cos θ ) + {n}_{x} sin θ & {n}_{z}^{2} ( 1 - cos θ ) + cos θ\end{matrix} ) ( \begin{matrix}x \\ y \\ z\end{matrix} ) \qquad ( 10 )$$

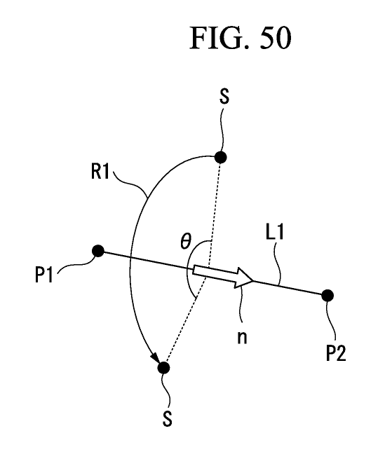

The relationship indicated by Expression (10) is the relationship in which the three-dimensional point S is rotated by an angle θ in a clockwise direction (right screw direction R1) by designating the unit direction vector n as a positive direction as illustrated in FIG. 50. The rotation angle θ is a rotation angle calculated in step SH708 based on a moving amount of the cursor C immediately before the point is designated in step SH706. In step SH712, the reference point 3 and the composing point rotationally move as in the three-dimensional point S rotationally moved as described above.

Next, the flow of the measurement process will be described with reference back to FIG. 41. The process of steps SH8 to SH11 is a process of changing the camera pose and checking the defect. In step SH8, the CPU 34c detects the press of the “Pose” button 4213 input by the user via the remote controller 23 in the “Setting” box 4210. If the “Pose” button 4213 is actuated, the camera pose of the 3D object OB after modification is changeable in the “Measurement Image” box 611.

In step SH9, the CPU 34c performs a process of changing the transparency of the 3D object OB after the modification and re-displaying the 3D object OB at the transparency after the change in the “Measurement Image” box 611. At this time, it is desirable to set the transparency low so that the 3D object OB is easily viewable.

In step SH10, the CPU 34c detects an operation (drag operation) for moving the cursor C in the up/down/left/right direction while the user performs a click or the like using the cursor C by operating the remote controller 23, and changes the camera pose of the 3D object OB after the modification based on a result of detection of the cursor C in the “Measurement Image” box 611. In step SH11, the CPU 34c performs a process of re-displaying the 3D object OB after the modification.

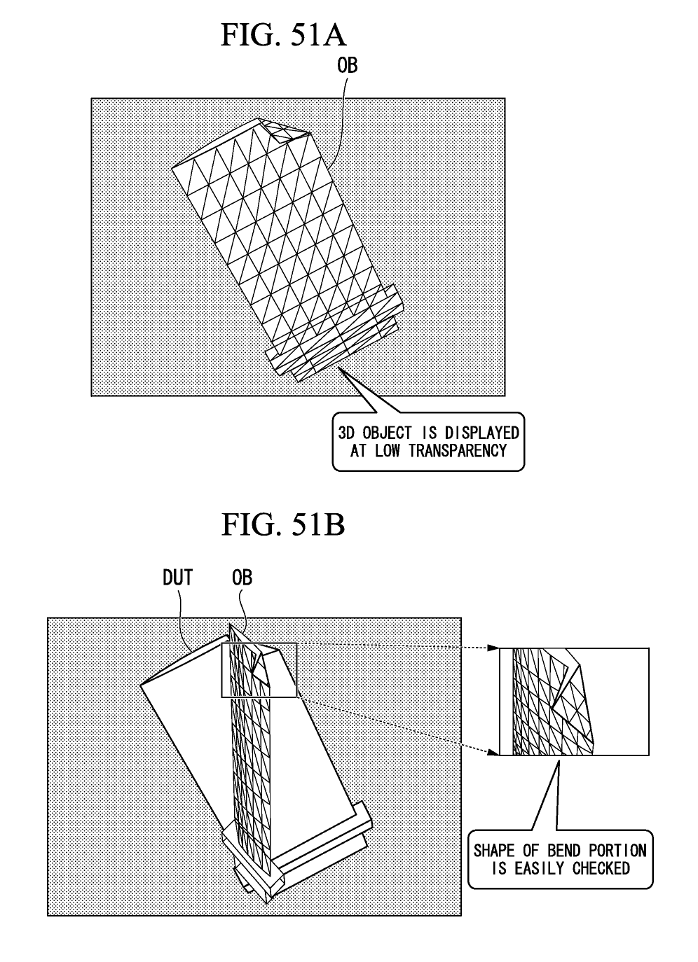

FIG. 51A illustrates the 3D object OB before the camera pose is changed in step SH10. Although the defect (bend portion) in the DUT of the measurement image is reproduced on the 3D object OB according to the 3D object modification process in step SH7, a shape of the bend portion may not necessarily be recognizable only by observing the 3D object OB corresponding to one camera pose.

FIG. 51B illustrates the 3D object OB after the camera pose is changed in step SH10. As described above, the user can more easily check a shape of the bend portion of the 3D object OB after the modification by changing the camera pose. That is, the user can check the shape of the bend portion of the 3D object OB in detail.

Because the user can observe the DUT only in one direction only from the measurement image, a state of a defect formed in the DUT is impossible to recognize in detail. However, the user can visually recognize a defect shape by modifying the 3D object according to the defect state and further observing the defect from various angles. Also, an amount of obtained defect information is significantly increased. Although not illustrated in FIG. 41, the user can change the camera pose of the 3D object OB any number of times after the modification as long as no GUI within the measurement window 4200 other than the “Pose” button 4213 is operated. That is, the process of steps SH10 and SH11 can be sequentially iterated.

The process of steps SH12 to SH14 is a process of ending the measurement process. In step SH12, the CPU 34c detects the press of the “Close” button 4224 input by the user via the remote controller 23 in the measurement window 4200. If the “Close” button 4224 is actuated, the process moves to step SH13.

In step SH13, the CPU 34c performs a process of returning the 3D object OB to a shape before the modification (a shape of the 3D object OB when the measurement window 4200 has been opened) and re-displaying the 3D object OB in the “Measurement Image” box 611. In step SH14, the CPU 34c does not display the measurement window 4200. If the process of step SH14 ends, the measurement process ends.

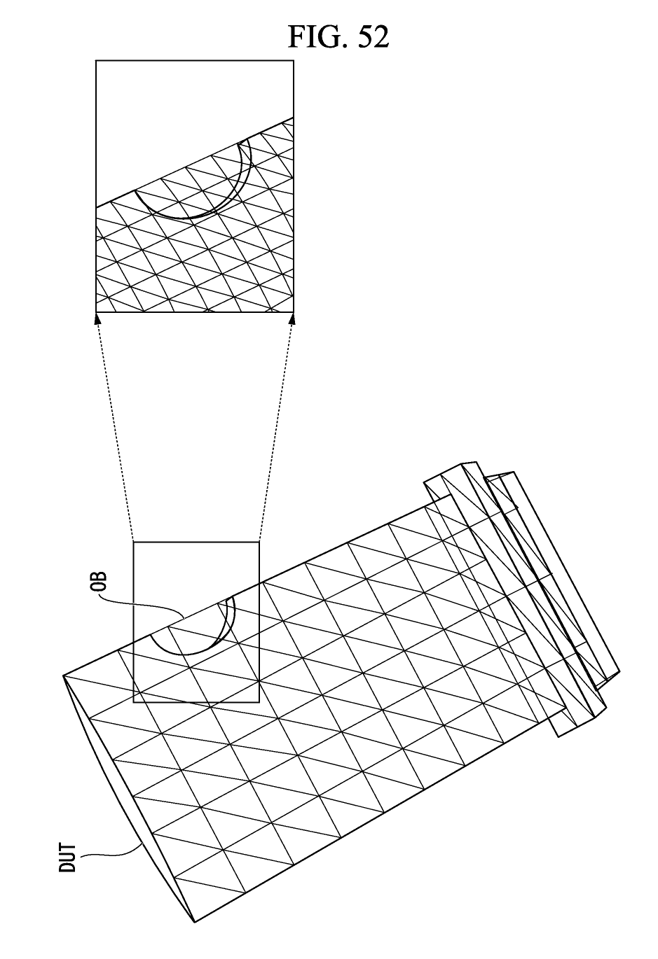

Next, the measurement process when the user has selected “crack” as the type of defect of the “Defect” combo box 4211 in step SH5 will be described. After the end of the 3D matching process of step SG, the DUT and the 3D object OB as illustrated in FIG. 52 are displayed in the “Measurement Image” box 611. Here, the DUT imaged in the measurement image has a cracked side. That is, the DUT has a crack as a defect.

The entire flow of the measurement process is the same as that of the measurement process illustrated in FIG. 41. However, if the DUT imaged in the measurement image has the crack as a defect, the user selects “crack” in the “Defect” combo box 4211 in step SH5. In addition, if “crack” is selected as a type of defect in step SH6, text boxes indicating “Width,” “Depth,” and “Area” of the defect in the “Result” box 4220 are displayed.

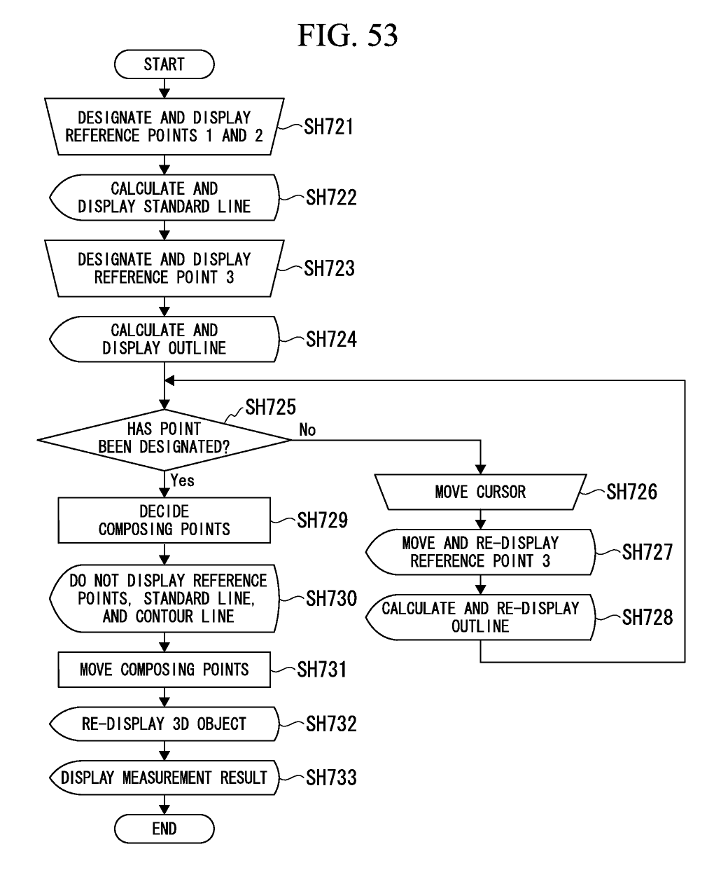

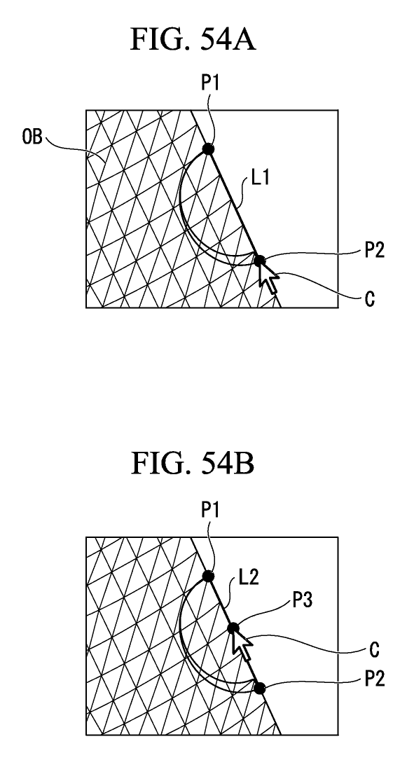

FIG. 53 illustrates a flow of the 3D object modification process when “crack” is selected in the “Defect” combo box 4211. If the user designates the reference points 1 and 2 (P1 and P2) for the 3D object by means of the cursor C in the “Measurement Image” box 611 in step SH721 as illustrated in FIG. 54A, the CPU 34c performs a process of calculating three-dimensional coordinates of the designated reference points 1 and 2 based on plane coordinates in the position of the cursor C and displaying the reference points 1 and 2 on the 3D object OB as black circle marks. The reference points 1 and 2 become standard points (first standard points) when the 3D object OB is modified. The user designates the three-dimensional points on the 3D object OB positioned at two ends of the crack portion in the DUT as the reference points 1 and 2.

In step SH722, the CPU 34c calculates a three-dimensional line connecting the designated reference points 1 and 2 in a standard line. Further, in step SH722, the CPU 34c performs a process of displaying the standard line L1 as a straight line in the “Measurement Image” box 611 as illustrated in FIG. 54A.

If the user designates a reference point 3 (P3) for the 3D object OB by means of the cursor C in the “Measurement Image” box 611 in step SH723 as illustrated in FIG. 54B, the CPU 34c performs a process of calculating three-dimensional coordinates of the designated reference point 3 based on plane coordinates in the position of the cursor C and displaying the reference point 3 on the 3D object OB as a black circle mark. The reference point 3 becomes a standard point (second standard point) when the 3D object OB is modified. The user designates a point on the standard line L1 positioned between the reference points 1 and 2 as the reference point 3.

In step SH724, the CPU 34c calculates a three-dimensional curve connecting the designated reference points 1, 3, and 2 as an outline. Further, in step SH724, the CPU 34c uses a process of displaying an outline L2 as a curve in the “Measurement Image” box 611 as illustrated in FIG. 54B. At this time, a spline interpolation curve connecting the reference points 1, 3, and 2 is used as the calculated outline.

In step SH725, the CPU 34c checks whether or not the user has designated a point in the “Measurement Image” box 611. Here, the CPU 34c checks whether or not the modification of the 3D object OB has been completed according to whether or not the point has been designated.

If the user moves the cursor C as will be described later, the reference point 3 moves according to movement of the cursor C. If a position of the moved reference point 3 is consistent with a position of an outline of a crack portion in the DUT of the measurement image, the user designates the point (third standard point). If the point has been designated, the process moves to step SH729. If no point has been designated, the process moves to step SH726.

In step SH726, the CPU 34c detects a movement instruction of the cursor C input by the user via the remote controller 23 in the “Measurement Image” box 611, and calculates a position and the amount of movement of the cursor C based on the movement instruction.

In step SH727, the CPU 34c moves the reference point 3 to the same position as a current position of the cursor C in the “Measurement Image” box 611 and calculates the three-dimensional coordinates of the reference point 3 after the movement. Further, in step SH727, the CPU 34c re-displays the reference point 3 after the movement in the “Measurement Image” box 611.

In step SH728, the CPU 34c calculates a three-dimensional curve connecting the reference points 1, 3 and 2 as an outline based on the three-dimensional coordinates of the reference point 3 moved in step SH727. Further, in step SH728, the CPU 34c re-displays the outline in the “Measurement Image” box 611. The outline is curved and modified according to the position of the reference point 3.

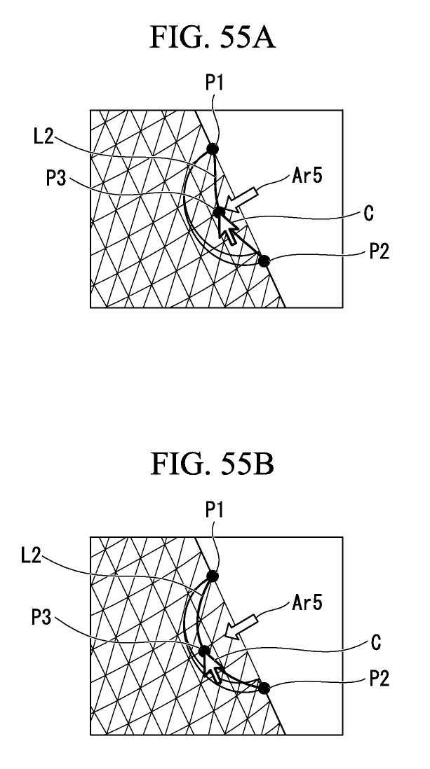

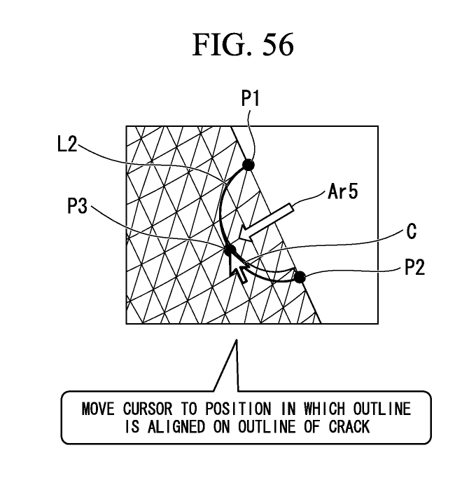

At this time, as illustrated in FIGS. 55A to 56, it can be seen that the reference point 3 moves as indicated by an arrow Ar5 in correspondence with movement of the cursor C and the reference point 3 after the movement and the outline L2 calculated based on the reference point 3 are re-displayed in the “Measurement Image” box 611.

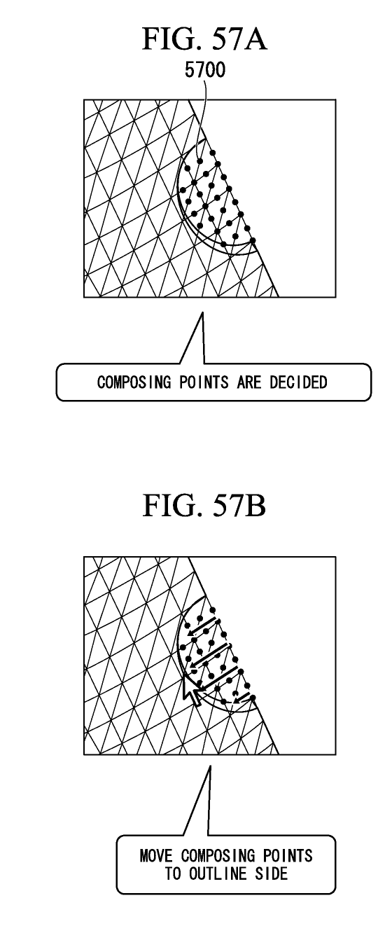

In step SH729, the CPU 34c decides composing points. The decided composing points are three-dimensional points 5700 constituting the 3D object OB positioned inside a graphic surrounded by a standard line and an outline in the “Measurement Image” box 611 as illustrated in FIG. 57A.

In step SH730, the CPU 34c does not display the reference point and the standard line already displayed in the “Measurement Image” box 611. In step SH731, the CPU 34c performs a process of moving all composing points to an outline side as illustrated in FIG. 57B.

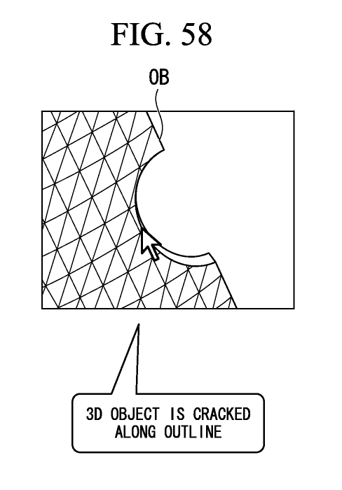

In step SH732, the CPU 34c re-displays the 3D object OB in the “Measurement Image” box 611 based on the moved composing points as illustrated in FIG. 58. At this time, it can be seen that a side of the 3D object OB (a side of a blade) is modified to be cracked to the left side of the screen using the standard line as the axis. Although not illustrated, a side of the 3D object can be modified to protrude to the right side of the screen by adjusting a movement position of the cursor C.

In step SH733, the CPU 34c calculates measurement results based on the reference points 1 and 2 and the reference point 3 after the movement and displays the calculated measurement results in the “Result” box 4220. In crack measurement, the width, depth, and area of the crack portion are calculated. The width of the crack portion is the length of the standard line L1 (a three-dimensional distance between the reference point 1 and the reference point 2). The depth of the crack portion is a three-dimensional length of a perpendicular line descended from the reference point 3 to the standard line L1. The area of the crack portion is an area of a three-dimensional plane surrounded by the standard line L1 and the outline L2. The width, depth, and area of the calculated crack portion are expressed in corresponding text boxes, respectively. If the process of step SH733 ends, the measurement process ends.

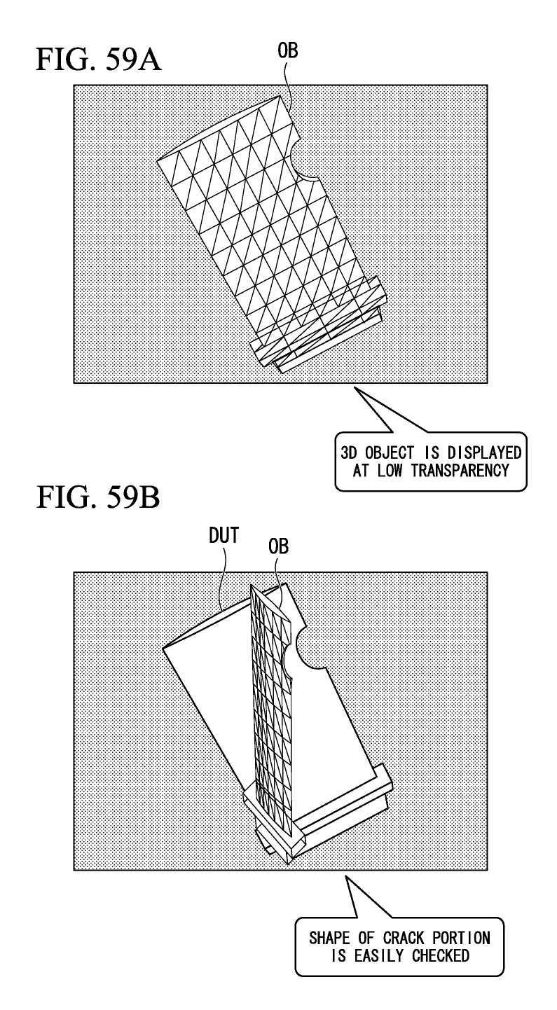

FIG. 59A illustrates the 3D object OB before the camera pose changes in step SH10. Although a defect (crack portion) in the DUT of the measurement image is reproduced on the 3D object OB according to the 3D object modification process in step SH7, a shape of the crack portion may not necessarily be recognizable only by observing the 3D object OB corresponding to one camera pose.

FIG. 59B illustrates the 3D object OB after the camera pose changes in step SH10. As described above, the user can more easily check the shape of the crack portion of the 3D object OB after the modification by changing the camera pose. That is, the user can check the shape of the crack portion of the 3D object OB in detail.

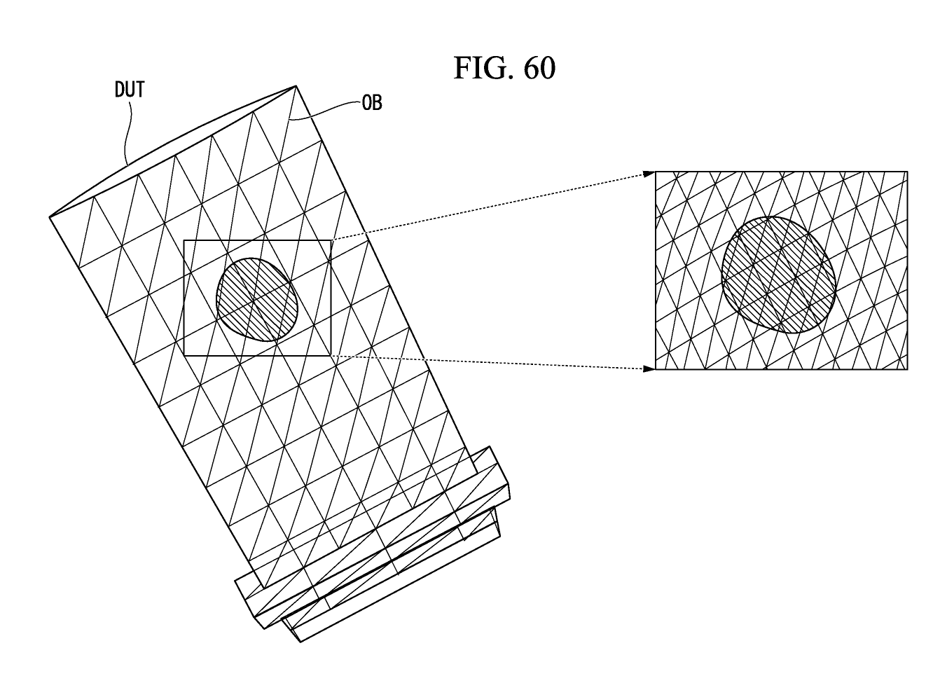

Next, the measurement process when the user selects “dent” as the type of defect of the “Defect” combo box 4211 in step SH5 will be described. After the 3D matching process of step SG ends, the DUT and the 3D object OB as illustrated in FIG. 60 are displayed in the “Measurement Image” box 611. Here, the DUT imaged in the measurement image is in a state of a dented surface. That is, the DUT has a dent as a defect.

The entire flow of the measurement process is the same as the flow of the measurement process illustrated in FIG. 41. However, when the DUT imaged in the measurement image has the defect of the dent, the user selects “dent” in the “Defect” combo box 4211. In addition, if “dent” is selected as the type of defect in step SH6, text boxes indicating “Width” and “Depth” of the defect are displayed in the “Result” box 4220.

If “dent” is selected in the “Defect” combo box 4211, the flow of the 3D object modification process is the same as the flow of the 3D object modification process illustrated in FIG. 53. Hereinafter, the flow of the 3D object modification process when “dent” is selected in the “Defect” combo box 4211 will be described using FIG. 53.

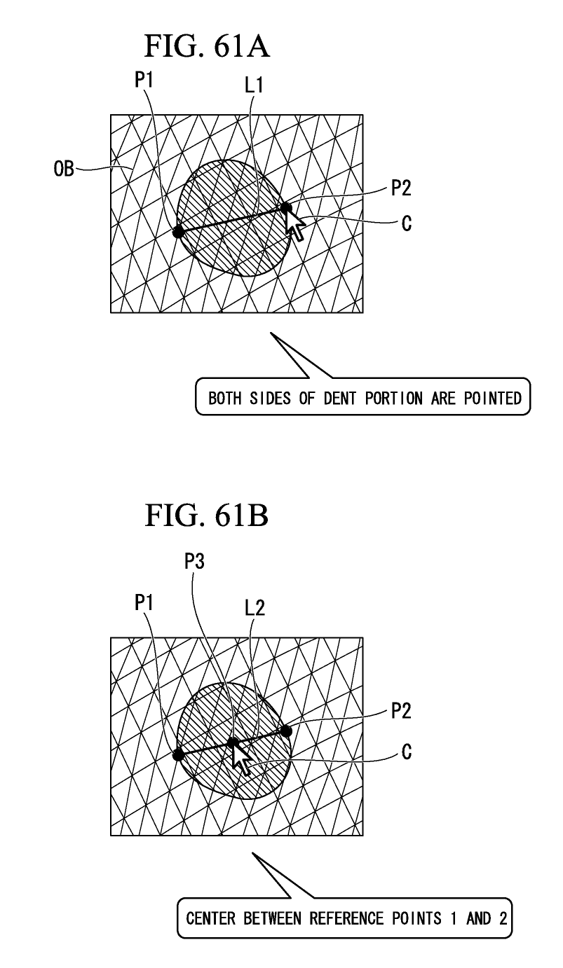

If the user designates reference points 1 and 2 (P1 and P2) for the 3D object OB by means of the cursor C in the “Measurement Image” box 611 in step SH721 as illustrated in FIG. 61A, the CPU 34c performs a process of calculating three-dimensional coordinates of the designated reference points 1 and 2 based on plane coordinates in the position of the cursor C and displaying the reference points 1 and 2 on the 3D object OB as black circle marks. The reference points 1 and 2 become standard points (first standard points) when the 3D object OB is modified. The user designates three-dimensional points on the 3D object OB positioned at two ends of the dent portion in the DUT as the reference points 1 and 2.

In step SH722, the CPU 34c calculates a three-dimensional line connecting the designated reference points 1 and 2 in a standard line. Further, in step SH722, the CPU 34c performs a process of displaying a standard line L1 as a straight line in the “Measurement Image” box 611 as illustrated in FIG. 61A.

If the user designates the reference point 3 (P3) for the 3D object OB by means of the cursor C in step SH723 as illustrated in FIG. 61B, the CPU 34c performs a process of calculating three-dimensional coordinates of the designated reference point 3 based on plane coordinates in the position of the cursor C and displaying the reference point 3 on the 3D object OB as a black circle mark. The reference point 3 becomes a standard point (second standard point) when the 3D object OB is modified. The user designates a point on the standard line L1 positioned between the reference points 1 and 2 as the reference point 3.

In step SH724, the CPU 34c calculates a three-dimensional curve connecting the designated reference points 1, 3, and 2 in an outline. Further, in step SH724, the CPU 34c performs a process of displaying an outline L2 as a curve in the “Measurement Image” box 611 as illustrated in FIG. 61B. At this time, a spline interpolation curve connecting the reference points 1, 3, and 2 is used as the calculated outline.

In step SH725, the CPU 34c checks whether or not the user has designated the point in the “Measurement Image” box 611. Here, the CPU 34c checks whether or not the modification of the 3D object OB has been completed according to whether or not the point has been designated.

If the user moves the cursor C as will be described later, the reference point 3 moves according to the movement of the cursor C. If a position of the moved reference point 3 is consistent with a position of an outline (dent) of a depth direction of the dent portion in the DUT of the measurement image, the user designates a point (third standard point). If the point is designated, the process moves to step SH729. If no point is designated, the process moves to step SH726.

In step SH726, the CPU 34c detects a movement instruction of the cursor C input by the user via the remote controller 23 in the “Measurement Image” box 611, and calculates a position and a moving amount of the cursor C based on the movement instruction.

In step SH727, the CPU 34c moves the reference point 3 to the same position as the current position of the cursor C in the “Measurement Image” box 611 and calculates three-dimensional coordinates of the reference point 3 after the movement. Further, in step SH727, the CPU 34c re-displays the reference point 3 after the movement in the “Measurement Image” box 611.

In step SH728, the CPU 34c calculates a three-dimensional curve connecting the reference points 1, 3, and 2 in an outline based on the three-dimensional coordinates of the reference point 3 moved in step SH727. Further, in step SH728, the CPU 34c re-displays the outline in the “Measurement Image” box 611. The outline is curved and modified according to the position of the reference point 3.

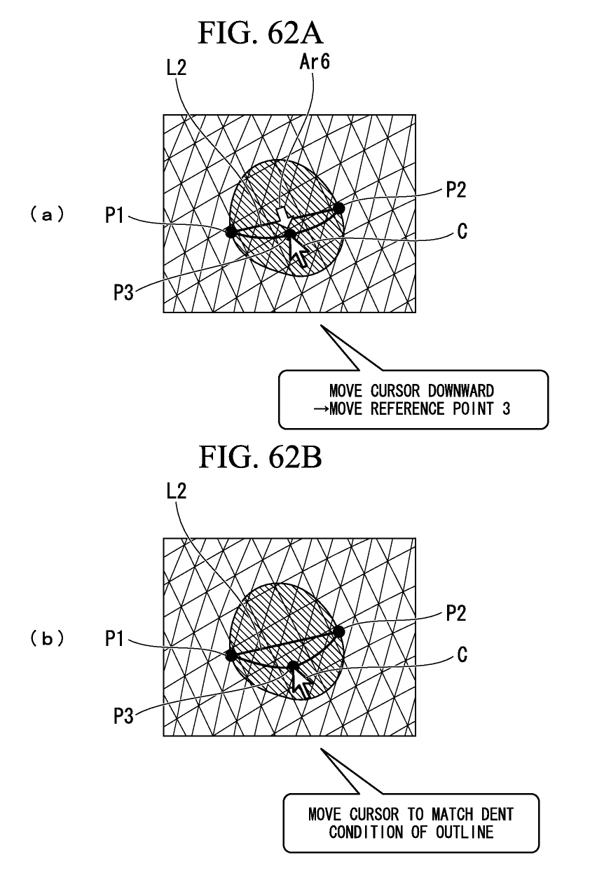

At this time, as illustrated in FIGS. 62A and 62B, it can be seen that the reference point 3 moves as indicated by an arrow Ar6 in correspondence with movement of the cursor C and the reference point 3 after the movement and the outline L2 calculated based on the reference point 3 are re-displayed in the “Measurement Image” box 611.

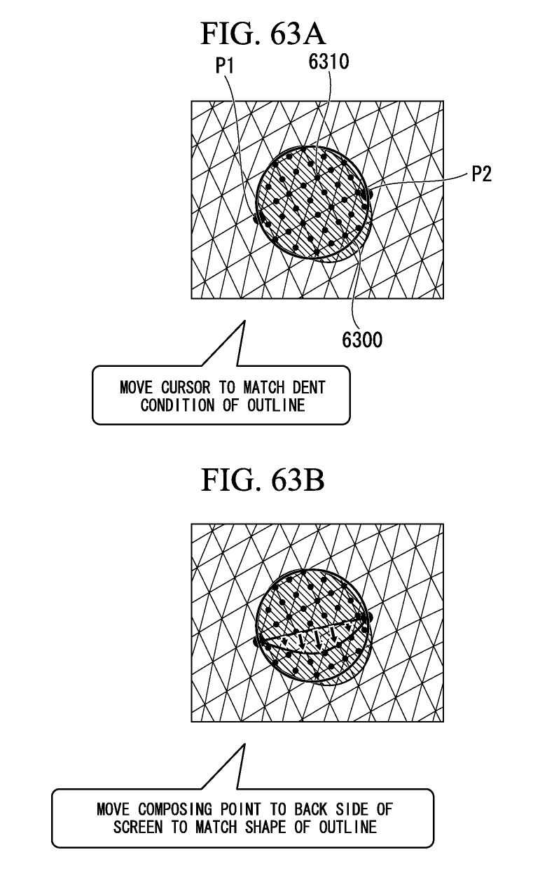

In step SH729, the CPU 34c decides composing points. Here, the decided composing points are three-dimensional points 6310 constituting the 3D object OB positioned inside a circle 6300 having a distance between the reference points 1 and 2 as a diameter in the “Measurement Image” box 611 as illustrated in FIG. 63A.

In step SH730, the CPU 34c does not display the reference points and the standard line already displayed in the “Measurement Image” box 611. In step SH731, the CPU 34c performs a process of moving all composing points as illustrated in FIG. 63B. At this time, the composing points move to the back side of the screen so that a shape formed by the composing points matches a shape of the outline L2.

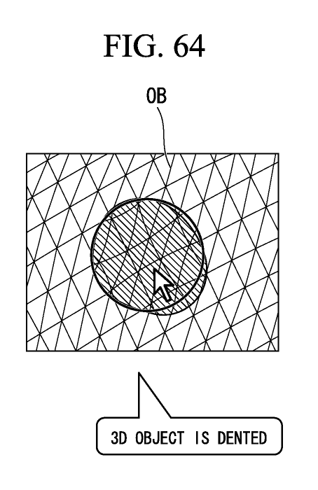

In step SH732, the CPU 34c re-displays the 3D object OB based on the moved composing points in the “Measurement Image” box 611 as illustrated in FIG. 64. At this time, it can be seen that the surface of the 3D object OB (the surface of the blade) is modified to be dented to the back side of the screen using the standard line as the axis. Although not illustrated, it is possible to modify the surface of the 3D object to protrude to the front side of the screen by adjusting a movement position of the cursor C.

In step SH733, the CPU 34c calculates measurement results based on the reference points 1 and 2 and the reference point 3 after the movement, and displays the calculated measurement results in the “Result” box 4220. In dent measurement, a width and depth of the dent portion are calculated. The width of the dent portion is a length of the standard line L1 (a three-dimensional distance between the reference point 1 and the reference point 2). The depth of the dent portion is a three-dimensional length of a perpendicular line descended from the bottom of the dent portion in the 3D object OB after the modification to the standard line L1. The calculated width and depth of the dent portion are displayed in text boxes corresponding thereto. If the process of step SH733 ends, the measurement process ends.

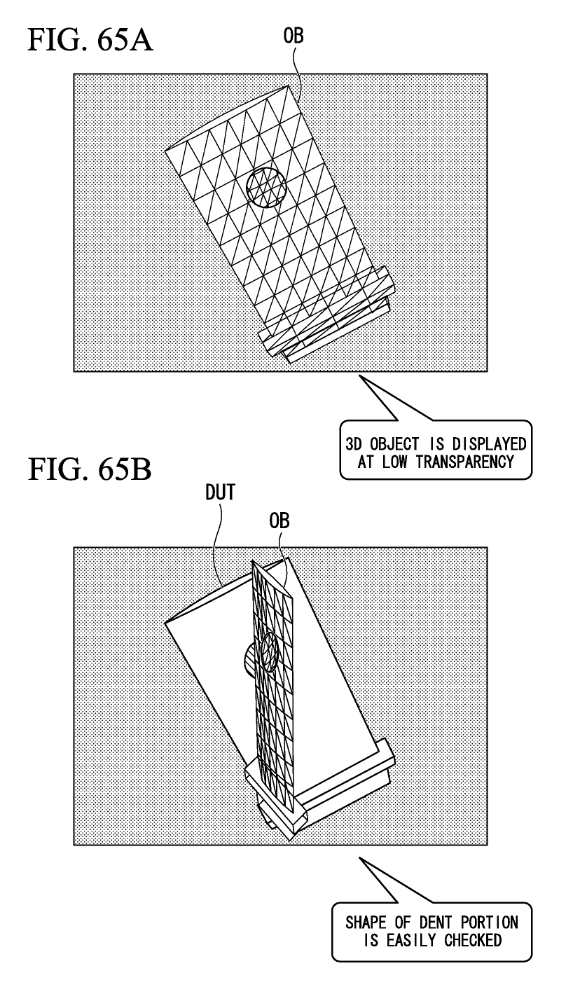

FIG. 65A illustrates the 3D object OB before the camera pose changes in step SH 10. Although the defect (dent portion) in the DUT of the measurement image is reproduced on the 3D object OB according to the 3D object modification process in step SH7, a shape of the dent portion may not necessarily be recognizable only by observing the 3D object OB corresponding to one camera pose.

FIG. 65B illustrates the 3D object OB after the camera pose changes in step SH10. As described above, the user can more easily check the shape of the dent portion of the 3D object OB after the modification by changing the camera pose. That is, the user can check the shape of the dent portion of the 3D object OB in detail.

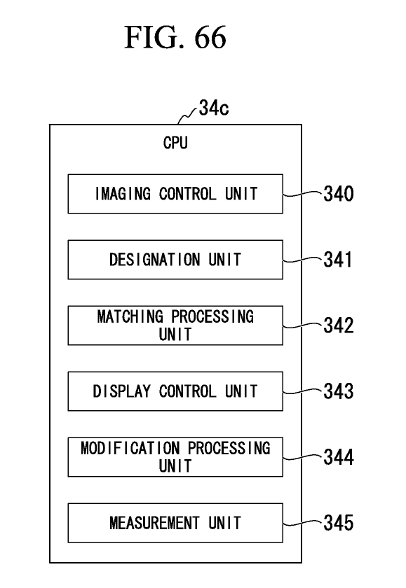

In the first preferred embodiment, the CPU 34c performs measurement by performing the above-described process according to 3D measurement software, which is software (a program) defining a procedure and content of a series of processes related to the measurement. FIG. 66 illustrates a functional configuration necessary for the CPU 34c. In FIG. 66, only the functional configuration related to the measurement of the first preferred embodiment is illustrated, and other functional configurations are omitted. The functional configuration of the CPU 34c includes an imaging control unit 340, a designation unit 341, a matching processing unit 342, a display control unit 343, a modification processing unit 344, and a measurement unit 345.

The imaging control unit 340 controls the light source 32 and the angle control unit 33 or controls the imaging element 30b. Based on an instruction input by the user via the remote controller 23, the designation unit 341 designates (sets) a reference point (measurement) corresponding to a position designated on the measurement image or the 3D object image, a reference point (3D), and a reference point during the 3D object modification process. The matching processing unit 342 calculates a reference graphic (measurement) and the reference graphic (3D) based on the reference point (measurement) and the reference point (3D) designated by the designation unit 341, and calculates a change amount of the camera pose necessary for matching by carrying out geometric calculations of the reference graphic (measurement) and the reference graphic (3D).

The display control unit 343 controls content or a display state of the image displayed on the monitor 22. In particular, the display control unit 343 causes the measurement image and the 3D object to be displayed in a mutually matched state by adjusting the pose of the 3D object based on the change amount of the camera pose calculated by the matching processing unit 342. Although the pose of only the 3D object is adjusted, the present invention is not limited thereto. The pose of the measurement image including the DUT may be adjusted or the poses of the measurement image and the 3D object may be adjusted. In addition, the display control unit 343 adjusts the pose of the 3D object modified by the 3D object modification process based on the change instruction of the camera pose input by the user via the remote controller 23.

The modification process unit 344 performs a process of modifying the 3D object based on reference points designated by the designation unit 341. The measurement unit 345 calculates the width, area, and angle of a bend portion, the width, depth, and area of a crack portion, and the width and depth of a dent portion based on the reference points designated by the designation unit 341. Although a defect is measured based on reference points serving as standards of modification of the 3D object in the 3D object modification process in the first preferred embodiment, defect measurement (for example, measurement of a three-dimensional distance between designated reference points) may be performed based on reference points arbitrarily designated by the user on the 3D object modified according to the 3D object modification process. Part or all of the functional configurations illustrated in FIGS. 46A and 46B may be replaced with specific hardware configured by arranging an analog circuit or a digital circuit for implementing a function necessary for measurement.

As described above, in the first preferred embodiment, the 3D object is modified after the pose (camera pose) of at least one of the measurement image and the 3D object is adjusted so that the pose of the measurement image including the DUT, which is an observation target, is close to the pose of the 3D object, which is an object of CG, in the “Measurement Image” box 611. Further, the pose (camera pose) of the 3D object changes according to the instruction by the user. Thereby, a defect state is easily visually recognizable because the user observes the 3D object after the modification from various angles. In addition, it is possible to obtain detailed information regarding the size of a defect by measuring the 3D object after the modification.

In addition, it is possible to associate two reference points in a simple method by associating reference points (measurement) and reference points (3D) based on the order in which the reference points (measurement) and the reference points (3D) have been designated, and reduce a processing time necessary for matching.

In addition, it is possible to reduce a processing time necessary for matching while maintaining the precision of matching by performing matching based on geometric calculations of a reference graphic (measurement) on a measurement image and a reference graphic (3D) obtained by projecting a triangle constituted by the reference points (measurement) on the 3D object on the screen plane.

In addition, the user can easily view the measurement image and easily designate the reference points (measurement) by setting the transparency of the 3D object to be high when the user designates the reference points (measurement).

In addition, it is possible to reduce the processing time necessary for matching by re-displaying the 3D object when the 3D matching process ends without re-displaying the 3D object having a high processing load during the 3D matching process.

While preferred embodiments of the present invention have been described and illustrated above, it should be understood that these are examples of the present invention and are not to be considered as limiting. Additions, omissions, substitutions, and other modifications can be made without departing from the scope of the present invention. Accordingly, the present invention is not to be considered as being limited by the foregoing description, and is only limited by the scope of the claims.

What is claimed is:

1. An image processing apparatus comprising:
a display unit configured to display an image of an observation target and an image of an object having a pre-calculated three-dimensional shape corresponding to the observation target;
an adjustment unit configured to adjust a pose of at least one of the image of the observation target and the image of the object so that the pose of the image of the observation target is close to the pose of the image of the object;
a processing unit configured to perform a process of modifying the object for the image of the object based on standard points designated on the image of the object after the adjustment unit performs the adjustment; and
a change unit configured to change the pose of the image of the object after the processing unit performs the process.

2. The image processing apparatus according to claim 1, wherein the processing unit performs a process of modifying the object for the image of the object based on a standard line based on a plurality of first standard points designated on the image of the object and a second standard point designated on the image of the object.

3. The image processing apparatus according to claim 2, wherein the processing unit performs a process of modifying the object for the image of the object so that the second standard point moves to a third standard point based on the standard line, the second standard point, and the third standard point designated on the image of the object.

4. The image processing apparatus according to claim 1, wherein the standard points are designated on the image of the object based on an instruction input via an input device.

5. An image processing apparatus comprising:
a display unit configured to display an image of an observation target and an image of an object having a pre-calculated three-dimensional shape corresponding to the observation target;
an adjustment unit configured to adjust a pose of at least one of the image of the observation target and the image of the object so that the pose of the image of the observation target is close to the pose of the image of the object;
a processing unit configured to perform a process of modifying the object for the image of the object based on a shape of the object after the adjustment unit performs the adjustment; and
a change unit configured to change the pose of the image of the object after the processing unit performs the process.

6. The image processing apparatus according to claim 5, wherein the processing unit performs a process of modifying the object for the image of the object based on a standard line based on a plurality of first standard points forming a contour of the object in the image of the object and a second standard point forming the contour of the object in the image of the object.

7. The image processing apparatus according to claim 6, wherein the processing unit performs a process of modifying the object for the image of the object so that the second standard point moves to a third standard point based on the standard line, the second standard point, and the third standard point forming the contour of the object in the image of the object.

8. The image processing apparatus according to claim 1, further comprising:
a measurement unit configured to calculate three-dimensional coordinates on the object corresponding to a point designated on the image of the object and calculating a size of the object based on the calculated three-dimensional coordinates.

9. The image processing apparatus according to claim 2, further comprising:
a measurement unit configured to calculate three-dimensional coordinates on the object corresponding to a point designated on the image of the object and calculating a size of the object based on the calculated three-dimensional coordinates.

10. The image processing apparatus according to claim 3, further comprising:
a measurement unit configured to calculate three-dimensional coordinates on the object corresponding to a point designated on the image of the object and calculating a size of the object based on the calculated three-dimensional coordinates.

11. The image processing apparatus according to claim 4, further comprising:
a measurement unit configured to calculate three-dimensional coordinates on the object corresponding to a point designated on the image of the object and calculating a size of the object based on the calculated three-dimensional coordinates.

12. The image processing apparatus according to claim 5, further comprising:
a measurement unit configured to calculate three-dimensional coordinates on the object corresponding to a point designated on the image of the object and calculating a size of the object based on the calculated three-dimensional coordinates.

13. The image processing apparatus according to claim 6, further comprising:
a measurement unit configured to calculate three-dimensional coordinates on the object corresponding to a point designated on the image of the object and calculating a size of the object based on the calculated three-dimensional coordinates.

14. The image processing apparatus according to claim 7, further comprising:
a measurement unit configured to calculate three-dimensional coordinates on the object corresponding to a point designated on the image of the object and calculating a size of the object based on the calculated three-dimensional coordinates.

15. A non-transitory computer-readable recording medium storing a program for causing a computer to perform the steps of:
displaying an image of an observation target and an image of an object having a pre-calculated three-dimensional shape corresponding to the observation target;
adjusting a pose of at least one of the image of the observation target and the image of the object so that the pose of the image of the observation target is close to the pose of the image of the object;
modifying the object for the image of the object based on standard points designated on the image of the object after the adjusting step; and
changing the pose of the image of the object after the modifying step.

16. A non-transitory computer-readable recording medium storing a program for causing a computer to perform the steps of:
displaying an image of an observation target and an image of an object having a pre-calculated three-dimensional shape corresponding to the observation target;
adjusting a pose of at least one of the image of the observation target and the image of the object so that the pose of the image of the observation target is close to the pose of the image of the object;
modifying the object for the image of the object based on a shape of the object after the adjusting step; and
changing the pose of the image of the object after the modifying step.
